(19) United States
(12) Patent Application Publication
(10) Pub. No.: US 2015/0350772 A1
(43) Pub. Date: Dec. 3, 2015

(54) SMART SENSOR FOR ALWAYS-ON OPERATION

(71) Applicant: INVENSENSE, INC., San Jose, CA (US)

(72) Inventors: Omid Oliaei, Sunnyvale, CA (US); Fariborz Assaderaghi, Emerald Hills, CA (US)

(21) Appl. No.: 14/628,686

(22) Filed: Feb. 23, 2015

Related U.S. Application Data
(63) Continuation-in-part of application No. 14/293,502, filed on Jun. 2, 2014.

(51) Int. Cl. H04R 3/00

(52) U.S. Cl. CPC H04R 3/00; H04R 2201/003

(57) ABSTRACT

Smart sensors comprising one or more microelectromechanical systems (MEMS) sensors and a digital signal processor (DSP) in a sensor package are described. An exemplary smart sensor can comprise a MEMS acoustic sensor or microphone and a DSP housed in a package or enclosure comprising a substrate and a lid and a package substrate that defines a back cavity for the MEMS acoustic sensor or microphone. Provided implementations can also comprise a MEMS motion sensor housed in the package or enclosure. Embodiments of the subject disclosure can provide improved power management and battery life from a single charge by intelligently responding to trigger events or wake events while also providing an always on sensor that persistently detects the trigger events or wake events. In addition, various physical configurations of smart sensors and MEMS sensor or microphone packages are described.

### CROSS-REFERENCE TO RELATED APPLICATIONS

This application is a continuation-in-part of U.S. patent application Ser. No. 14/293,502, filed Jun. 2, 2014 and entitled SMART SENSOR FOR ALWAYS-ON OPERATION, the entirety of which application is hereby incorporated by reference.

### TECHNICAL FIELD

The subject disclosure relates to microelectromechanical systems (MEMS) sensors.

### BACKGROUND

Conventionally, mobile devices are becoming increasingly lightweight and compact. Contemporaneously, user demand for applications that are more complex, provide persistent connectivity, and/or are more feature-rich is in conflict with the desire to provide lightweight and compact devices that also provide a tolerable level of battery life before requiring recharging. Thus, the desire to reduce power consumption of such devices has resulted in various methods to place devices or systems into various “sleep” modes. For example, these methods can selectively deactivate components (e.g., processors or portions thereof, displays, backlights, communications components), can selectively slow down the clock rate of associated components (e.g., processors, memories), or can provide a combination of steps to reduce power consumption.

However, when devices are in such “sleep” modes, a signal based on a trigger event, or a wake event, (e.g., a pressed button, expiration of a preset time, device motion), can be used to wake or reactivate the device. In the case of wake events caused by an interaction with the device, these interactions can be detected by sensors and/or associated circuits in the device (e.g., buttons, switches, accelerometers). However, because such sensors and/or the circuits used to monitor the sensors are energized to be able to detect interactions with the device, e.g., to be able to monitor the device environment constantly, the sensors and their associated circuits continually drain power from the battery, even while a device is in such “sleep” modes.

In addition, circuits used to monitor the sensors typically employ general purpose logic or specific power management components thereof, which can be more power-intensive than is necessary to monitor the sensors and provide a useful trigger event or wake event. For example, decisions whether or not to wake up a device can be determined by a power management component of a processor of the device based on receiving an interrupt or control signal from the circuit including the sensor. That is, the interrupts can be sent to a relatively power-intensive microprocessor and associated circuitry based on gross inputs from relatively indiscriminant sensors. This can result in inefficient power management and reduced battery life from a single charge, because the entire processor can be fully powered up inadvertently based on inaccurate or inadvertent trigger events or wake events.

As a result, conventional sensors such as acoustic sensors and microphones and/or associated power management schemes typically consumes excessive amount of power, for example, by utilizing microphones that are continuously powered on. In other conventional solutions, conventional sensors and/or associated power management schemes may not be compatible with existing product designs.

It is thus desired to provide smart sensors that improve upon these and other deficiencies. The above-described deficiencies are merely intended to provide an overview of some of the problems of conventional implementations, and are not intended to be exhaustive. Other problems with conventional implementations and techniques, and corresponding benefits of the various aspects described herein, may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In a non-limiting example, a sensor comprising a microelectromechanical systems (MEMS) acoustic sensor is provided, according to aspects of the subject disclosure. Thus, an exemplary sensor can comprise a microelectromechanical systems (MEMS) acoustic sensor. In addition, an exemplary sensor includes a digital signal processor (DSP) configured to generate a control signal for a system processor that can be communicably coupled with the sensor. Furthermore, an exemplary sensor can include a package comprising a lid and a package substrate. For instance, the package can have a port adapted to receive acoustic waves or acoustic pressure. In addition, the package can house the MEMS acoustic sensor and the back cavity of the MEMS acoustic sensor can house the DSP. Other exemplary sensors can include a MEMS motion sensor.

Moreover, an exemplary microphone package is described. For instance, an exemplary microphone package can include a MEMS microphone and a DSP configured to control a device external to the microphone package. In a non-limiting aspect, an exemplary microphone package can have a lid and a package substrate. For instance, the microphone package can have a port that can receive acoustic pressure or acoustic waves. In another aspect, the microphone package can house the MEMS microphone and the DSP in a back cavity of the MEMS microphone. In a further non-limiting aspect, exemplary methods associated with a smart sensor are provided. Other exemplary microphone packages can include a MEMS motion sensor.

In other exemplary embodiments, an exemplary smart sensor comprising a MEMS acoustic sensor configured to process sound/ultrasound pressure waves in an event detection mode is provided. The exemplary smart sensor can further comprise an event detection component comprising an application specific integrated circuit configured to detect a sound/ultrasound pressure event associated with the sound/ultrasound pressure waves and generate a control signal in response to receiving a signal associated with the sound/ultrasound pressure waves from the MEMS sensor. In addition, an exemplary square sensor can comprise a multiplexer configured to generate a multiplexed output signal in response to receiving the control signal and the signal associated with the sound/ultrasound pressure waves and a package comprising a lid, a package substrate, a port adapted to receive the sound/ultrasound pressure waves, and an output adapted to transmit the multiplexed output signal, wherein the package houses the MEMS acoustic sensor, the multiplexer, and the event detection component.

In still further exemplary embodiments exemplary systems are provided comprising a MEMS sensor package configured to process sound/ultrasound pressure waves in an event detection mode and to transmit a multiplexed output signal comprising data associated with the sound/ultrasound pressure waves and an interrupt on an output associated with the package. Exemplary systems can further comprise one or more of a sensor hub, a Coder/Decoder (CODEC), and/or a host processor configured to receive a portion of the multiplexed output signal and to transmit a clock signal to the MEMS sensor package based in part on the multiplexed output signal. In further exemplary embodiments systems, according to the subject disclosure can comprise a demultiplexer associated with the one or more sensor hub, the CODEC, or the host processor, wherein the demultiplexer is configured to receive the multiplexed output signal and to transmit one or more of the data associated with the sound/ultrasound pressure waves or the interrupt to one or more of the sensor hub, the CODEC, or the host processor.

Further non-limiting embodiments provide exemplary methods that can comprise processing sound/ultrasound pressure waves with a MEMS) sensor in an event detection mode. Exemplary methods as described herein can further comprise receiving a signal associated with the sound/ultrasound pressure waves from the MEMS sensor at an event detection component comprising an application specific integrated circuit, detecting an sound/ultrasound pressure event associated with the sound/ultrasound pressure waves with the event detection component generating a control signal in response to the detecting the sound/ultrasound pressure event, and/or transmitting the control signal and the signal associated with the sound/ultrasound pressure waves via an output of a package comprising a lid, a package substrate, the MEMS sensor, and the event detection component.

These and other embodiments are described in more detail below.

### BRIEF DESCRIPTION OF THE DRAWINGS

Various non-limiting embodiments are further described with reference to the accompanying drawings, in which:

FIG. 1 depicts a functional block diagram of a microelectromechanical systems (MEMS) smart sensor, in which a MEMS acoustic sensor facilitates generating control signals with an associated digital signal processor (DSP);

FIG. 2 depicts another functional block diagram of a MEMS smart sensor, in which a MEMS motion sensor, in conjunction with a MEMS acoustic sensor, facilitates generating control signals with an associated DSP;

FIG. 3 depicts a non-limiting sensor or microphone package (e.g., comprising a MEMS acoustic sensor or microphone), in which a DSP can be integrated with an ASIC associated with the MEMS acoustic sensor or microphone;

FIG. 4 depicts another sensor or microphone package (e.g., comprising a MEMS acoustic sensor or microphone), in which a MEMS acoustic sensor or microphone can be electrically coupled and mechanically affixed on top of an ASIC, in which a DSP can be integrated;

FIG. 5 depicts a further sensor or microphone package (e.g., comprising a MEMS acoustic sensor or microphone), in which a MEMS acoustic sensor or microphone is electrically coupled and mechanically affixed on top of an ASIC, and in which a standalone DSP is housed within the sensor or microphone package;

FIG. 6 depicts a non-limiting sensor or microphone package (e.g., comprising a MEMS acoustic sensor or microphone and a MEMS motion sensor), in which a standalone DSP is provided in a MEMS acoustic sensor or microphone package;

FIG. 7 depicts another sensor or microphone package (e.g., comprising a MEMS acoustic sensor or microphone and a MEMS motion sensor), in which a MEMS acoustic sensor or microphone is electrically coupled and mechanically affixed on top of an ASIC, in which a DSP is integrated;

FIG. 8 illustrates a schematic cross section of an exemplary smart sensor, in which a MEMS acoustic sensor or microphone facilitates generating control signals with an associated DSP;

FIG. 9 illustrates a schematic cross section of a further exemplary smart sensor, in which a MEMS motion sensor, in conjunction with a MEMS acoustic sensor, facilitates generating control signals with an associated DSP;

FIG. 10 illustrates a block diagram representative of an exemplary application of a smart sensor;

FIG. 11 depicts exemplary operating environments suitable for incorporation of exemplary embodiments of the subject disclosure;

FIG. 12 depicts exemplary embodiments comprising smart sensors that facilitate generating control signals according to non-limiting aspects of the subject disclosure;

FIG. 13 depicts further exemplary embodiments of smart sensors that facilitate generating control signals according to the subject disclosure;

FIG. 14 depicts exemplary systems comprising a smart sensor that facilitate generating control signals according to further aspects the subject disclosure;

FIG. 15 depicts an exemplary schema for event detection, generation of control signals, and/or mode selection according to non-limiting aspects of the subject disclosure;

FIG. 16 depicts an exemplary flowchart of non-limiting methods associated with a smart sensor;

FIG. 17 depicts another exemplary flowchart of non-limiting methods associated with a smart sensor; and

FIG. 18 depicts a further non-limiting flowchart of exemplary methods associated with a smart sensor.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems, and methodologies are intended to be encompassed within the scope of the subject matter disclosed herein.

As described above, conventional power management of mobile devices can rely on relatively power-intensive microprocessor, or power management components thereof, and associated circuitry based on gross inputs from relatively indiscriminant sensors, which can result in inefficient power management and reduced battery life from a single charge.

As a result, conventional sensors such as acoustic sensors and microphones and/or associated power management schemes typically consumes excessive amount of power, for example, by utilizing microphones that are continuously powered on. In other conventional solutions, the conventional sensors and/or associated power management schemes may not be compatible with existing product designs. For example, as further described herein, the subject disclosure can provide exemplary implementations of sensors, smart sensors, microphones, sensors or microphone packages, and/or associated power management schemes compatible with existing product designs requiring a specific pin or input/output count, configuration, etc. associated with the existing product designs.

To these and/or related ends, various aspects of smart sensors are described. For example, the various embodiments of the apparatuses, techniques, and methods of the subject disclosure are described in the context of smart sensors. Exemplary embodiments of the subject disclosure provide always-on sensors with self-contained processing, decision-making, and/or inference capabilities.

For example, according to an aspect, a smart sensor can include one or more microelectromechanical systems (MEMS) sensors communicably coupled to a digital signal processor (DSP) (e.g., an internal DSP) within a package comprising the one or more MEMS sensors and the DSP. In a further example the one or more MEMS sensors can include a MEMS acoustic sensor or microphone. In yet another example, the one or more MEMS sensors can include a MEMS accelerometer.

In various embodiments, the DSP can process signals from the one or more MEMS sensors to perform various functions, e.g., keyword recognition, external device or system processor wake-up, control of the one or more MEMS sensors, etc. In a further aspect, the DSP of the smart sensor can facilitate performance control of the one or more MEMS sensors. For instance, the smart sensor comprising the DSP can perform self-contained functions (e.g., calibration, performance adjustment, change operation modes) guided by self-sufficient analysis of a signal from the one or more MEMS sensors (e.g., a signal related to sound, related to a motion, to other signals from sensors associated with the DSP, and/or any combination thereof) in addition to generating control signals based on one or more signals from the one or more MEMS sensors. Thus, a smart sensor can also include a memory or memory buffer to hold data or information associated with the one or more MEMS sensors (e.g., sound or voice information, patterns), to facilitate generating control signals based on a rich set of environmental factors associated with the one or more MEMS sensors.

According to an aspect, a smart sensor can facilitate always-on, low power operation of the smart sensor, which can facilitate more complete power down of an associated external device or system processor. For instance, a smart sensor as described can include a clock (e.g., a 32 kilohertz (kHz) clock). In a further aspect, smart sensor as described herein can operate on a power supply voltage below 1.5 volts (V) (e.g., 1.2 V). According to various embodiments, a DSP as described herein is compatible with complementary metal oxide semiconductor (CMOS) process nodes of 90 nanometers (nm) or below, as well as other technologies. As a non-limiting example, an internal DSP can be implemented on a separate die using a 90 nm or below CMOS process, as well as other technologies, and can be packaged with a MEMS sensor (e.g., within the enclosure or back cavity of a MEMS acoustic sensor or microphone), as further described herein.

In yet another aspect of the subject disclosure, the smart sensor can control a device or system processor that is external to the smart sensor and is communicably coupled thereto, for example, such as by transmitting a control signal to the device or system processor, which control signal can be used as a trigger event or a wake event for the device or system processor. As a further example, control signals from exemplary smart sensors can be employed by systems or devices comprising the smart sensors as trigger events or wake events, to control operations of the associated systems or devices, and so on. These control signals can be based on trigger events or wake events determined by the smart sensors comprising one or more MEMS sensors (e.g., acoustic sensor, motion sensor, other sensor), which can be recognized by the DSP. Accordingly, various embodiments of the smart sensors can provide autonomous wake-up decisions to wake up other components in the system or external devices associated with the smart sensors. For instance, the DSP can include Inter-Integrated Circuit (PC) and interrupt functionality to send control signals to system processors, external devices associated with the smart sensor, and/or application processors of devices such as a feature phones, smartphones, smart watches, tablets, eReaders, netbooks, automotive navigation devices, gaming consoles or devices, wearable computing devices, and so on.

Accordingly, because microphones comprise audio sensors that operate on acoustic signals, exemplary embodiments of the subject disclosure can facilitate generating control signals (e.g., interrupt signals, interrupt control signals, I²C signals). Moreover, exemplary embodiments of the subject disclosure can facilitate always-on operation of microphones for applications such as sound detection, voice activity detection, keyword spotting, ambient sound analysis, etc., for example, by employing acoustic sensors that can facilitate generating control signals (e.g., interrupt signals, interrupt control signals, I²C signals) for transmission to an exemplary processor (e.g., a system processor, a sensor hub, a main processor, an applications processor, etc.) based on detection of an acoustic event.

However, as further detailed below, various exemplary implementations can be applied to other areas of MEMS sensor design and packaging, without departing from the subject matter described herein.

### Exemplary Embodiments

Various aspects or features of the subject disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, parameters, etc. In other instances, well-known structures and devices are shown in block diagram form to facilitate description and illustration of the various embodiments.

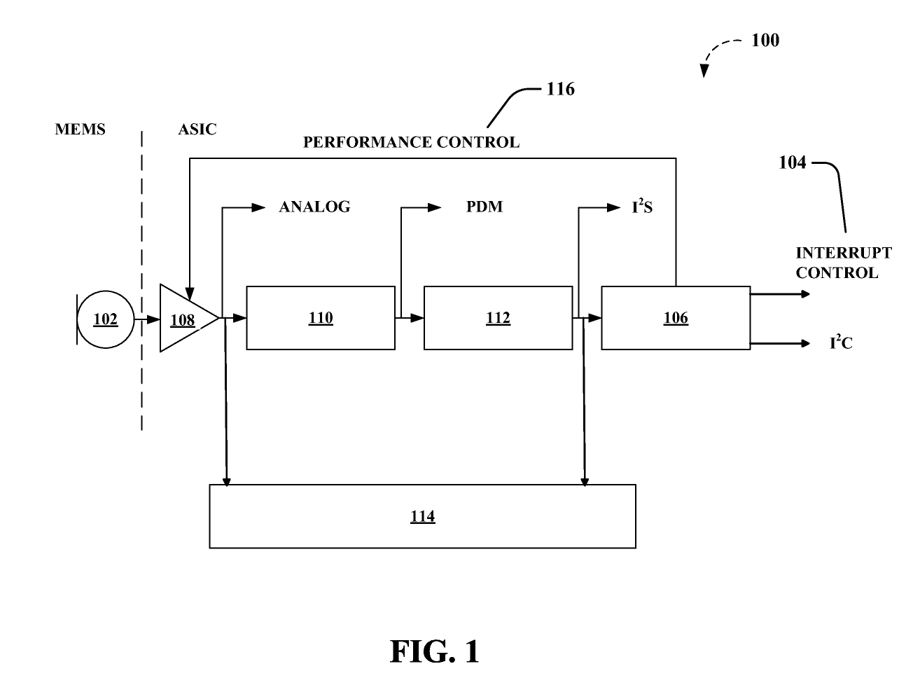

FIG. 1 depicts a functional block diagram of a microelectromechanical systems (MEMS) smart sensor 100, in which a MEMS acoustic sensor or microphone 102 can facilitate generating control signals 104 (e.g., interrupt control signals, I²C signals) with an associated digital signal processor (DSP) 106, according to various non-limiting aspects of the subject disclosure. As mentioned, DSP 106 can process signals from MEMS acoustic sensor or microphone 102 to perform various functions, e.g., keyword recognition, external device or system processor wake-up, control of one or more MEMS sensors For instance, DSP 106 can include PC and interrupt functionality to send control signal 104 to system processors (not shown), external devices (not shown) associated with the smart sensor, and/or application processors (not shown) of devices such as a feature phones, smartphones, smart watches, tablets, eReaders, netbooks, automotive navigation devices, gaming consoles or devices, wearable computing devices, and so on.

Control signals 104 can be used to control a device or system processor (not shown) communicably coupled with smart sensor 100. For instance, smart sensor 100 can control a device or system processor (not shown) that is external to smart sensor 100 and is communicably coupled thereto, for example, such as by transmitting control signal 104 to the device or system processor that can be used as a trigger event or a wake event for the device or system processor. As a further example, control signals 104 from smart sensor 100 can be employed by systems or devices comprising exemplary smart sensors as trigger events or wake events, to control operations of the associated systems or devices, and so on. Control signals 104 can be based on trigger events or wake events determined by smart sensor 100 comprising one or more MEMS sensors (e.g., MEMS acoustic sensor or microphone 102, motion sensor, other sensor), which can be recognized by DSP 106. Accordingly, various embodiments of smart sensor 100 can provide autonomous wake-up decisions to wake up other components in the system or external devices associated with smart sensor 100.

Smart sensor 100 can further comprise a buffer amplifier 108, an analog-to-digital converter (ADC) 110, and a decimator 112 to process signals from MEMS acoustic sensor or microphone 102. In the non-limiting example of smart sensor 100 comprising MEMS acoustic sensor or microphone 102, MEMS acoustic sensor or microphone 102 is shown communicably coupled to an external codec or processor 114 that can employ analog and/or digital audio signals (e.g., pulse density modulation (PDM) signals, Integrated Interchip Sound (I²S) signals, information, and/or data) as is known in the art. However, it should be understood that external codec or processor 114 is not necessary to enable the scope of the various embodiments described herein.

In a further aspect, DSP 106 of smart sensor 100 can facilitate performance control 116 of the one or more MEMS sensors. For instance, in an aspect, smart sensor 100 comprising DSP 106 can perform self-contained functions (e.g., calibration, performance adjustment, change operation modes) guided by self-sufficient analysis of a signal from the one or more MEMS sensors (e.g., a signal from MEMS acoustic sensor or microphone 102, signal related to a motion, other signals from sensors associated with DSP 106, other signals from external device or system processor (not shown), and/or any combination thereof) in addition to generating control signals 104 based on one or more signals from one or more MEMS sensors, or otherwise.

For instance, by combining DSP 106 with MEMS sensor or microphone 102 in the sensor or microphone package and dedicating the DSP 106 to the MEMS sensor or microphone 102, DSP 106 can provide additional controls over sensor or microphone 102 performance. For example, in a non-limiting aspect, DSP 106 can switch MEMS sensor or microphone 102 into different modes. As an example, as a low-power smart sensor 100, embodiments of the subject disclosure can generate trigger events or wake events, as described. However, DSP 106 can also facilitate configuring the MEMS sensor or microphone 102 as a high-performance microphone (e.g., for voice applications) versus a low performance microphone (e.g., for generating trigger events or wake events).

Thus, smart sensor 100 can also include a memory or memory buffer (not shown) to hold data or information associated with the one or more MEMS sensors (e.g., sound or voice information, patterns), in further non-limiting aspects, to facilitate generating control signals based on a rich set of environmental factors associated with the one or more MEMS sensors.

As described, smart sensor 100 can facilitate always-on, low power operation of the smart sensor 100, which can facilitate more complete power down of an associated external device (not shown) or system processor (not shown). For instance, smart sensor 100 as described can include a clock (e.g., a 32 kilohertz (kHz) clock). In a further aspect, smart sensor 100 can operate on a power supply voltage below 1.5 V (e.g., 1.2 V). As a non-limiting example, by employing the DSP 106 with MEMS acoustic sensor or microphone 102 to provide always-on, low power operation of the smart sensor 100, system processor or external device (not shown) can be more fully powered down while maintaining smart sensor 100 awareness of a rich set of environmental factors associated with the one or more MEMS sensors (e.g., one or more of MEMS acoustic sensor or microphone 102, motion sensor).

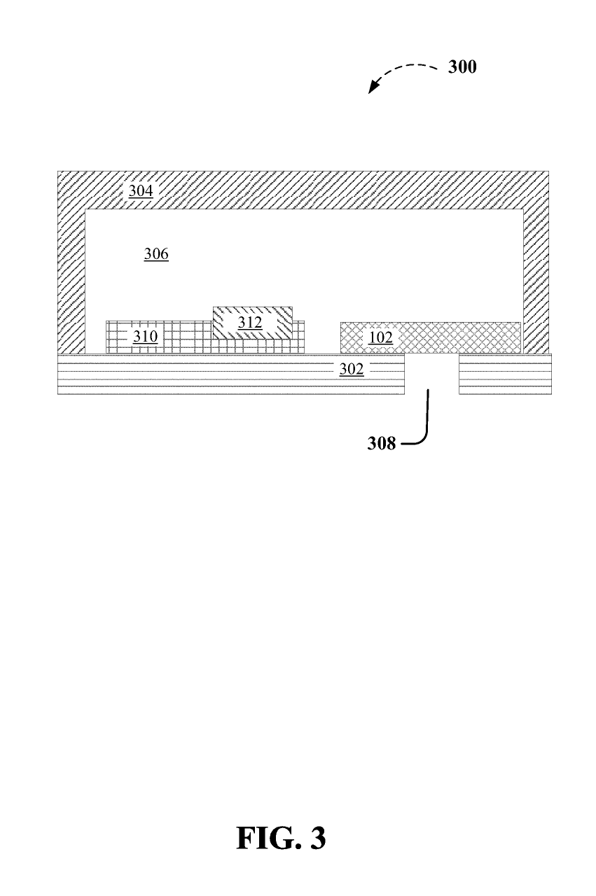

In a further non-limiting aspect, MEMS acoustic sensor or microphone 102 and DSP 106 are provided in a common sensor or microphone package or enclosure (e.g., comprising a lid and a sensor or microphone package substrate), such as a microphone package that defines a back cavity of MEMS acoustic sensor or microphone 102, for example, as further described below regarding FIGS. 3-9. According to various embodiments, DSP 106 can be compatible with CMOS process nodes of 90 nm or below, as well as other technologies. As a non-limiting example, DSP 106 can be implemented on a separate die using a 90 nm or below CMOS process, as well as other technologies, and can be packaged with one or more MEMS sensors (e.g., within the enclosure or back cavity of MEMS acoustic sensor or microphone 102), as further described herein. In another aspect, DSP 106 can be integrated with one or more of buffer amplifier 108, ADC 110, and/or decimator 112 associated with MEMS acoustic sensor or microphone 102 into a common ASIC, for example, as further described herein, regarding FIGS. 3-9.

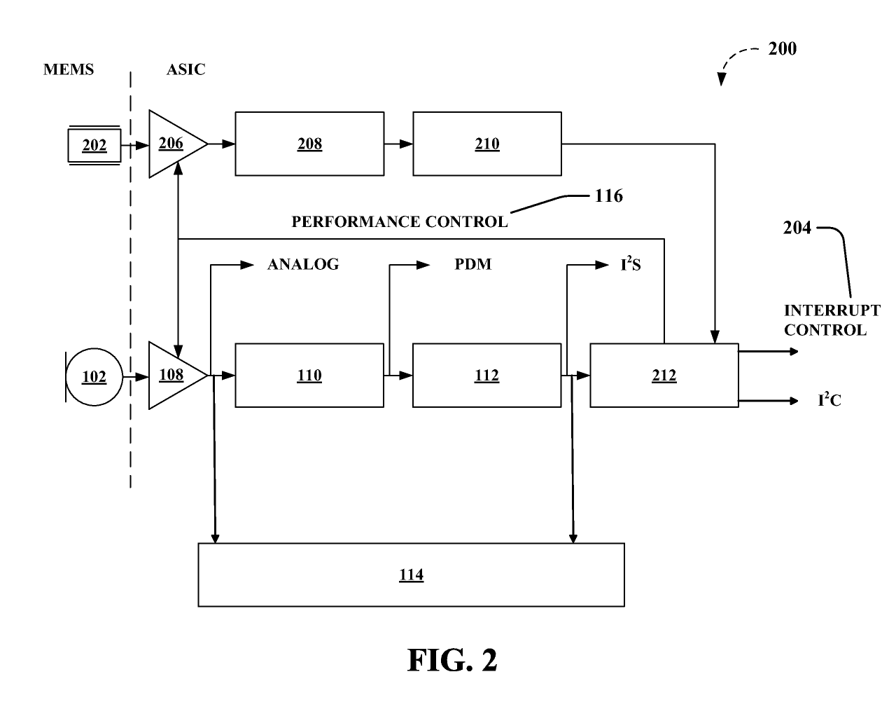

FIG. 2 depicts another functional block diagram of a MEMS smart sensor 200, in which the one or more MEMS sensors comprise a MEMS motion sensor 202, in conjunction with a MEMS acoustic sensor or microphone 102, and which can facilitate generating control signals 204. In addition to functionality and capabilities described above regarding FIG. 1, FIG. 2 provides a combination MEMS smart sensor 200, which can further comprise one or more of a MEMS motion sensor 202 (e.g., a MEMS accelerometer), a buffer amplifier 206, an ADC 208, and a decimator 210 to process signals from MEMS motion sensor 202, and a DSP 212.

In a non-limiting aspect, MEMS motion sensor 202 can comprise a MEMS accelerometer. In another aspect, the MEMS accelerometer can comprise a low-G accelerometer, characterized in that a low-G accelerometer can be employed in applications for monitoring relatively low acceleration levels, such as experienced by a handheld device when the device is held in a user's hand as the user is waving his or her arm. A low-G accelerometer can be further characterized by reference to a high-G accelerometer, which can be employed in applications for monitoring relatively higher levels of acceleration, such as might be useful in automobile crash detection applications. However, it can be appreciated that various embodiments of the subject disclosure described as employing a MEMS motion sensor 202 (e.g., a MEMS accelerometer, a low-G MEMS accelerometer) are not so limited.

As with FIG. 1 above, combination sensor 200 can be connected to external codec or processor 114 that can employ analog and/or digital audio signals (e.g., PDM signals, I²S signals, information, and/or data) as is known in the art. In addition, external codec process 114 can employ analog and/or digital signals, information, and/or data associated with MEMS motion sensor 202. However, it should be understood external codec or processor 114 is not necessary to enable the scope of the various embodiments described herein.

As described above regarding FIG. 1, DSP 212 can process signals from the one or more MEMS sensors (e.g., one or more of MEMS acoustic sensor or microphone 102, MEMS motion sensor 202) to perform various functions, e.g., keyword recognition, external device or system processor wake-up, control of one or more MEMS sensors For instance, DSP 212 can include PC and interrupt functionality to send control signal 204 to system processors (not shown), external devices (not shown) associated with the smart sensor, and/or application processors (not shown) of devices such as a feature phones, smartphones, smart watches, tablets, eReaders, netbooks, automotive navigation devices, gaming consoles or devices, wearable computing devices, and so on.

Control signals 204 can be used to control a device or system processor (not shown) communicably coupled with smart sensor 200. For instance, smart sensor 200 can control a device or system processor (not shown) that is external to smart sensor 200 and is communicably coupled thereto, for example, such as by transmitting control signal 204 to the device or system processor that can be used as a trigger event or a wake event for the device or system processor. As a further example, control signals 204 from smart sensor 200 can be employed by systems or devices comprising exemplary smart sensors as trigger events or wake events, to control operations of the associated systems or devices. For instance, control signals 204 can be based on trigger events or wake events determined by smart sensor 200 comprising one or more MEMS sensors (e.g., MEMS acoustic sensor or microphone 102, MEMS motion sensor 202, other sensor), which can be recognized by the DSP 212. Accordingly, various embodiments of smart sensor 200 can provide autonomous wake-up decisions to wake up other components in the system or external devices associated with smart sensor 200.

A non-limiting example of a trigger event or wake event input involving embodiments of the subject disclosure (e.g., comprising one or more of a MEMS acoustic sensor or microphone 102, MEMS motion sensor 202, such as a MEMS accelerometer, other sensor) could be the action of removing a mobile phone from a pocket. In this instance, smart sensor 200 can recognize the distinct sound of the mobile phone being grasped, the mobile phone rustling against the fabric of the pocket, and so on. As well, smart sensor 200 can recognize a distinct motion experienced by the mobile phone being grasped, lifted, rotated, and/or turned, and so on, to display the mobile phone to a user at a certain angle. While any one of the inputs, separately (e.g., one of the audio input from MEMS acoustic sensor or microphone 102 or accelerometer input of MEMS motion sensor 202) may not necessarily indicate a valid wake event, smart sensor 200 can recognize the combination of the two inputs as a valid wake event. Conversely, employing an indiscriminate sensor in this scenario would likely require discarding many of the inputs (e.g., the distinct sound of the mobile phone being grasped, the mobile phone rustling against the fabric of the pocket, the distinct motion experienced by the mobile phone being grasped, lifted, rotated, and/or turned, and so on) that could be employed as valid trigger events or wake events. Otherwise, employing an indiscriminate sensor in this scenario would likely result in too many false positives so as to reduce the utility of employing such an indiscriminate sensor in a power management scenario, for example, because the entire system processor or external device could be fully powered up inadvertently based on inaccurate or inadvertent trigger events or wake events.

In further exemplary embodiments, DSP 212 of smart sensor 200 can facilitate performance control 116 of the one or more MEMS sensors (e.g., one or more of MEMS acoustic sensor or microphone 102, MEMS motion sensor 202, other sensor). For instance, in an aspect, smart sensor 200 comprising DSP 212 can perform self-contained functions (e.g., calibration, performance adjustment, change operation modes) guided by self-sufficient analysis of a signal from the one or more MEMS sensors (e.g., a signal from one or more of the MEMS acoustic sensor or microphone 102, the MEMS motion sensor 202, another sensor, etc., other signals from sensors associated with DSP 212, other signals from external device or system processor (not shown), and/or any combination thereof) in addition to generating control signals 204 based on one or more signals from the one or more MEMS sensors, or otherwise.

Thus, smart sensor 200 can also include a memory or memory buffer (not shown) to hold data or information associated with the one or more MEMS sensors (e.g., sound or voice information, motion information, patterns), to facilitate generating control signal based on a rich set of environmental factors associated with the one or more MEMS sensors (e.g., one or more of MEMS acoustic sensor or microphone 102, MEMS motion sensor 202, other sensor).

As described, smart sensor 200 can facilitate always-on, low power operation of the smart sensor 200, which can facilitate more complete power down of an associated external device (not shown) or system processor (not shown). For instance, smart sensor 200 as described can include a clock (e.g., a 32 kilohertz (kHz) clock). In a further aspect, smart sensor 200 can operate on a power supply voltage below 1.5 V (e.g., 1.2 V). As a non-limiting example, by employing DSP 212 with MEMS acoustic sensor or microphone 202 and MEMS motion sensor 202 to provide always-on, low power operation of smart sensor 200, system processor or external device (not shown) can be more fully powered down while maintaining smart sensor 200 awareness of a rich set of environmental factors associated with the one or more MEMS sensors (e.g., one or more of MEMS acoustic sensor or microphone 102, MEMS motion sensor 202, other sensor).

In a further non-limiting aspect, MEMS acoustic sensor or microphone 102 and DSP 212 are provided in a common sensor or microphone package or enclosure (e.g., comprising a lid and a sensor or microphone package substrate), such as a microphone package that defines a back cavity of MEMS acoustic sensor or microphone 102, for example, as further described below regarding FIGS. 3-9. According to various embodiments, DSP 212 can be compatible with CMOS process nodes of 90 nm or below, as well as other technologies. As a non-limiting example, DSP 212 can be implemented on a separate die using a 90 nm or below CMOS process, as well as other technologies, and can be packaged with one or more MEMS sensors (e.g., within the enclosure or back cavity of MEMS acoustic sensor or microphone 102, MEMS motion sensor 202, other sensors), as further described herein. In another aspect, DSP 212 can be integrated with one or more of buffer amplifier 108, ADC 110, and/or decimator 112 associated with MEMS acoustic sensor or microphone 102, and/or with one or more of buffer amplifier 206, ADC 208, and/or decimator 210 associated with MEMS motion sensor 202 into a common ASIC, for example, as further described herein, regarding FIGS. 3-9.

FIGS. 3-7 illustrate schematic diagrams of exemplary configurations of components of MEMS smart sensors 100/200, according to various non-limiting aspects of the subject disclosure. For instance, FIG. 3 depicts a non-limiting sensor or microphone package 300 (e.g., comprising MEMS acoustic sensor or microphone 102). In an aspect, sensor or microphone package 300 can comprise an enclosure comprising a sensor or microphone package substrate 302 and a lid 304 that can house and define a back cavity 306 for MEMS acoustic sensor or microphone 102. The enclosure comprising sensor or microphone package substrate 302 and lid 304 can have a port 308 adapted to receive acoustic waves or acoustic pressure. Port 308 can also be located in lid 304 for other configurations of MEMS acoustic sensor or microphone 102 or can be omitted for certain other configurations of one or more MEMS sensors not requiring reception of acoustic waves or acoustic pressure. MEMS acoustic sensor or microphone 102 can be mechanically affixed to sensor or microphone package substrate 302 and can be communicably coupled thereto. Sensor or microphone package 300 can also comprise ASIC 310, for example, as described above regarding FIG. 1, and DSP 312 (e.g., DSP 106), which can be housed in the enclosure comprising a sensor or microphone package substrate 302 and a lid 304. In sensor or microphone package 300 depicted in FIG. 3, DSP 312 can be integrated with ASIC 310. ASIC 310 can be mechanically affixed to sensor or microphone package substrate 302 and can be communicably coupled to MEMS acoustic sensor or microphone 102 via sensor or microphone package substrate 302.

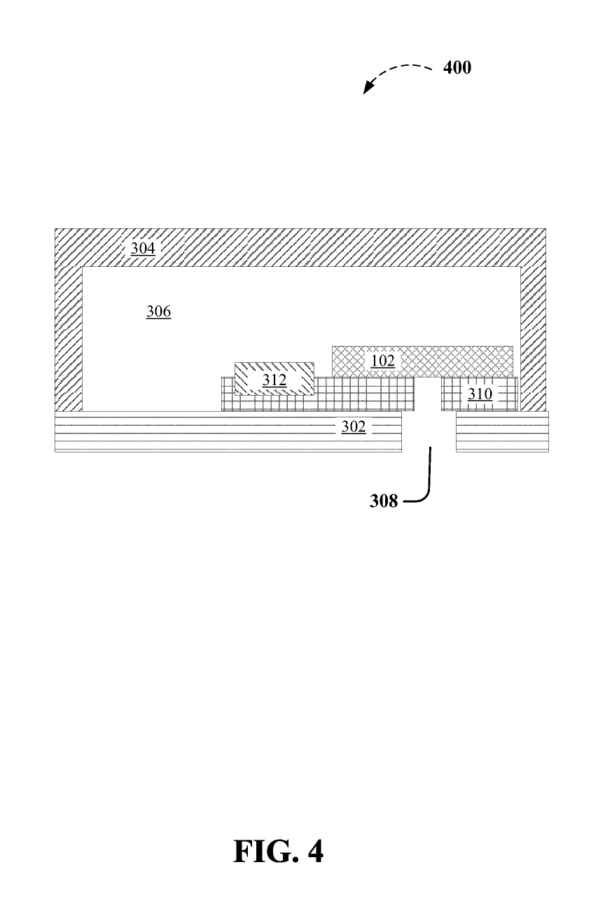

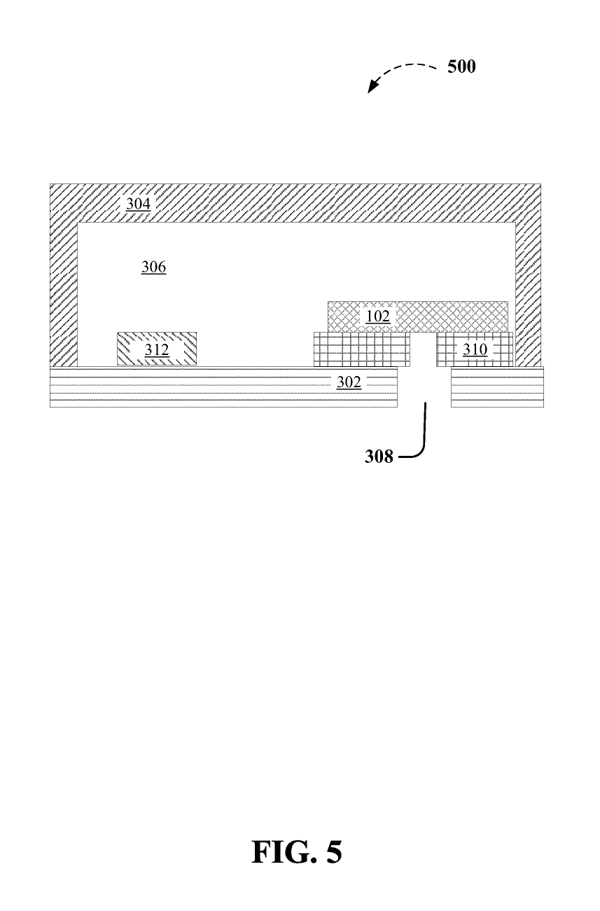

Turning to FIG. 4, for a sensor or microphone package 400, DSP 312 can be integrated with ASIC 310. ASIC 310 can be mechanically affixed to sensor or microphone package substrate 302 and can be communicably coupled thereto. MEMS acoustic sensor or microphone 102 can be mechanically affixed to ASIC 310 and can be communicably coupled thereto. FIG. 5 depicts a further sensor or microphone package 500 (e.g., comprising a MEMS acoustic sensor or microphone 102), in which MEMS acoustic sensor or microphone 102 can be communicably coupled and mechanically affixed on top of ASIC 310, and in which a standalone DSP 312 (e.g., DSP 106) can be housed within the sensor or microphone package 500. DSP 312 can be mechanically affixed to sensor or microphone package substrate 302 and can be communicably coupled to MEMS acoustic sensor or microphone 102 via sensor or microphone package substrate 302.

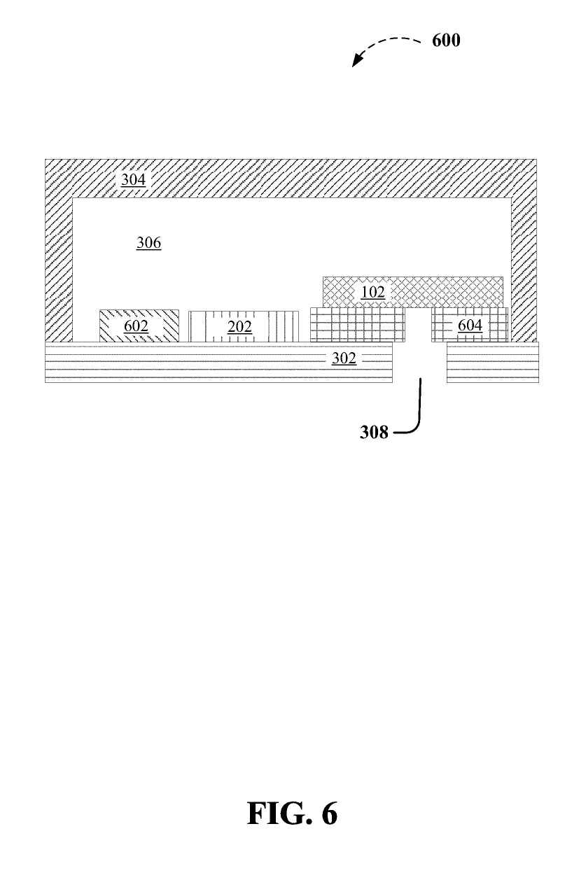

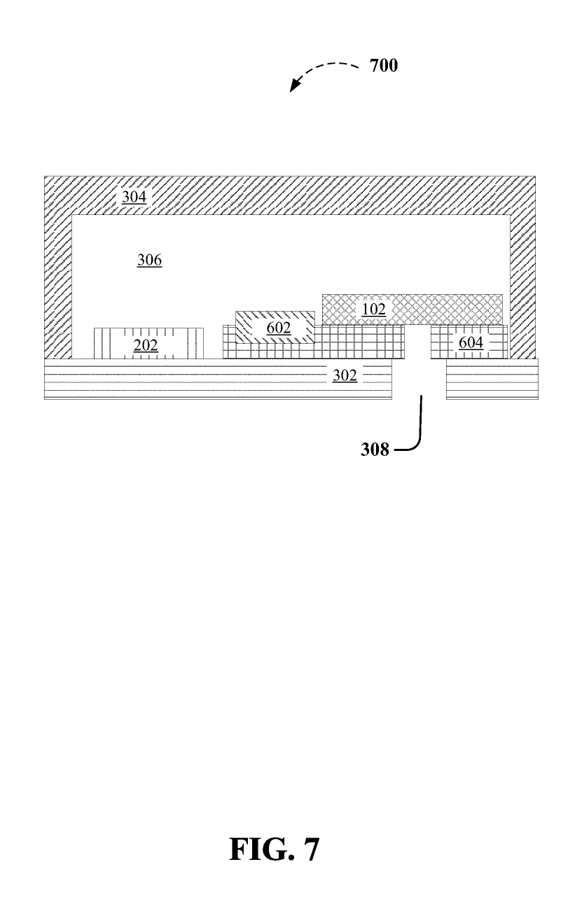

FIG. 6 depicts a non-limiting sensor or microphone package 600 (e.g., comprising a MEMS acoustic sensor or microphone 102 and a MEMS motion sensor 202), in which a standalone DSP 602 (e.g., DSP 212) can be provided in the MEMS acoustic sensor or microphone package 600. DSP 602 and MEMS motion sensor 202 can be mechanically affixed to sensor or microphone package substrate 302 and can be communicably coupled thereto. Sensor or microphone package 600 can also comprise ASIC 604, for example, as described above regarding FIG. 2. MEMS acoustic sensor or microphone 102 can be mechanically affixed to ASIC 604 and can be communicably coupled thereto as described above regarding FIG. 4. FIG. 7 depicts another sensor or microphone package 700 (e.g., comprising a MEMS acoustic sensor or microphone 102 and a MEMS motion sensor 202), in which MEMS acoustic sensor or microphone 102 can communicably coupled and can be mechanically affixed on top of ASIC 604, in which DSP 602 can be integrated.

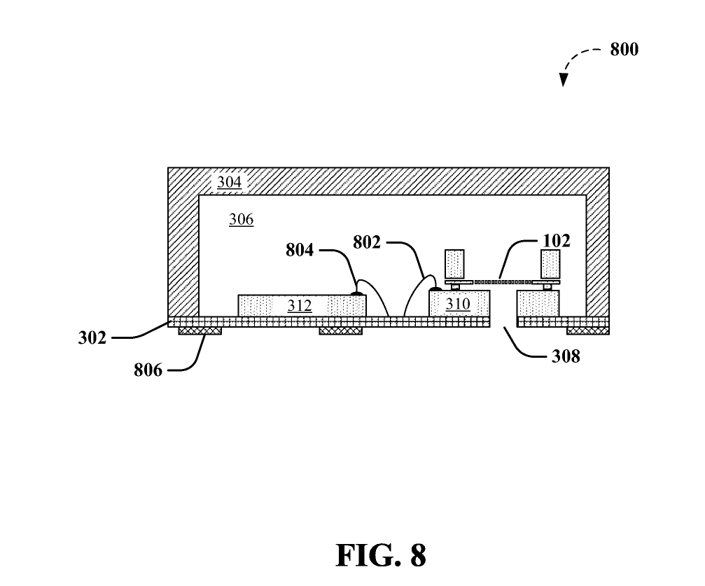

FIG. 8 illustrates a schematic cross section of an exemplary smart sensor 800, in which a MEMS acoustic sensor or microphone 102 facilitates generating control signal 104 with an associated DSP 312 (e.g., DSP 106), according to various aspects of the subject disclosure. Smart sensor 800 can include MEMS acoustic sensor or microphone 102 in an enclosure comprising a sensor or microphone package substrate 302 and a lid 304 that can house and define a back cavity 306 for MEMS acoustic sensor or microphone 102. Smart sensor 800 can further comprise DSP 312 (e.g., DSP 106), which can be housed in the enclosure comprising a sensor or microphone package substrate 302 and a lid 304. As above, the enclosure comprising package substrate 302 and lid 304 can have a port 308, or otherwise, adapted to receive acoustic waves or acoustic pressure. ASIC 310 can be mechanically affixed to sensor or microphone package substrate 302 and can be communicably coupled thereto via wire bond 802. MEMS acoustic sensor or microphone 102 can be mechanically affixed to ASIC 310 and can be communicably coupled thereto. DSP 312 can be mechanically affixed to sensor or microphone package substrate 302 and can be communicably coupled thereto via wire bond 804. Solder 806 on sensor or microphone package substrate 302 can facilitate connecting smart sensor 800 to an external substrate such as a customer printed circuit board (PCB) (not shown).

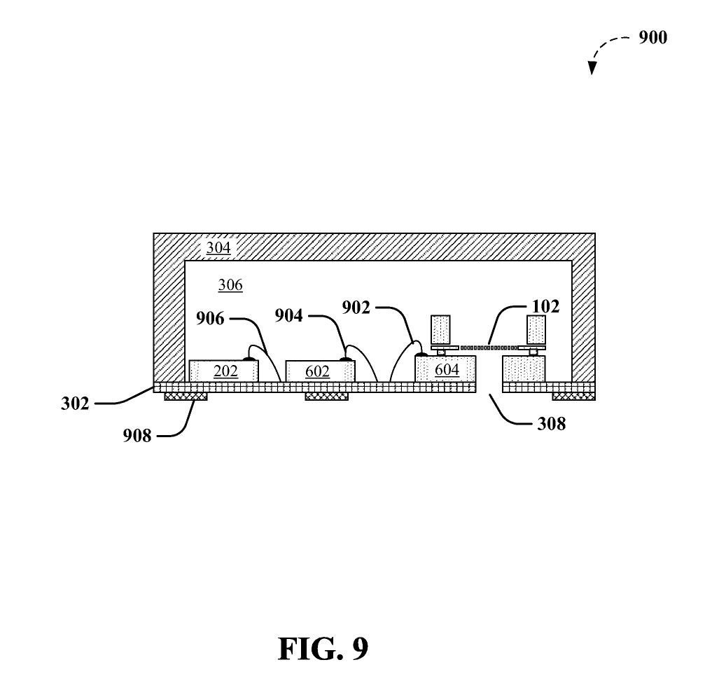

FIG. 9 illustrates a schematic cross section of a further non-limiting smart sensor 900, in which a MEMS motion sensor 202, in conjunction with a MEMS acoustic sensor or microphone 102, facilitates generating control signals 204 with an associated DSP 602 (e.g., DSP 212), according to further non-limiting aspects of the subject disclosure. Smart sensor 900 can include one or more of MEMS acoustic sensor or microphone 102, MEMS motion sensor 202, and so on, in an enclosure comprising a sensor or microphone package substrate 302 and a lid 304 that can house MEMS acoustic sensor or microphone 102 and MEMS motion sensor 202 and define a back cavity 306 for MEMS acoustic sensor or microphone 102. Smart sensor 900 can further comprise DSP 602 (e.g., DSP 212), which can be housed in the enclosure comprising a sensor or microphone package substrate 302 and a lid 304. As described, the enclosure comprising package substrate 302 and lid 304 can have a port 308, or otherwise, adapted to receive acoustic waves or acoustic pressure. ASIC 604 can be mechanically affixed to sensor or microphone package substrate 302 and can be communicably coupled thereto via wire bond 902. MEMS acoustic sensor or microphone 102 can be mechanically affixed to ASIC 604 and can be communicably coupled thereto. DSP 602 can be mechanically affixed to sensor or microphone package substrate 302 and can be communicably coupled thereto via wire bond 904. MEMS motion sensor 202 can be mechanically affixed to sensor or microphone package substrate 302 and can be communicably coupled thereto via wire bond 906. Solder 908 on sensor or microphone package substrate 302 can facilitate connecting smart sensor 900 to an external substrate such as a customer printed circuit board (PCB) (not shown).

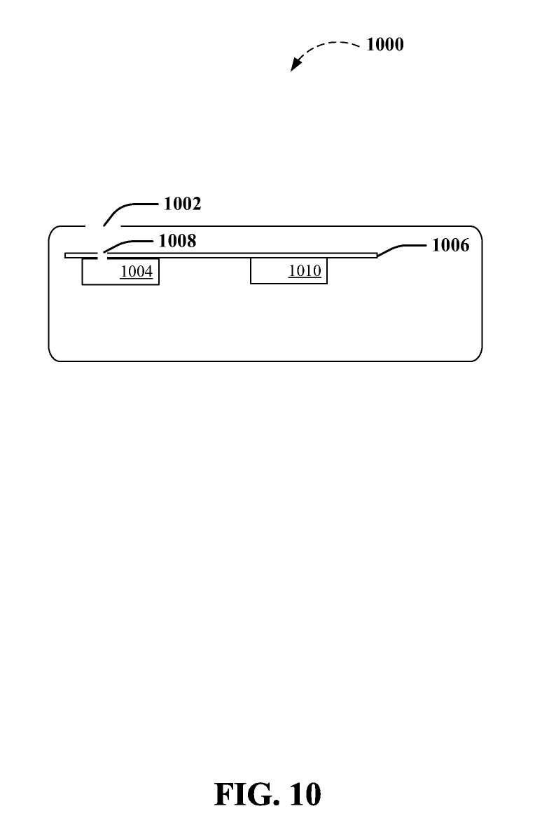

FIG. 10 illustrates a block diagram representative of an exemplary application of a smart sensor according to further aspects of the subject disclosure. More specifically, a block diagram of a host system 1000 is shown to include an acoustic port 1002 and a smart sensor 1004 (e.g., comprising one or more of MEMS acoustic sensor or microphone 102, MEMS motion sensor 202, other sensors) affixed to a PCB 1006 having an orifice 1008 or other means of passing acoustic waves or pressure to smart sensor 1004. In addition, host system 1000 can comprise a device 1010, such as a system processor, an external device associated with smart sensor 1004, and/or an application processor, that can be mechanically affixed to PCB 1006 and can be communicably coupled to smart sensor 1004, to facilitate receiving control signals 104/204, and/or other information and/or data, from smart sensor 1004. Examples of the smart sensor 1004 can comprise a smart sensor (e.g., comprising one or more of MEMS acoustic sensor or microphone 102, MEMS motion sensor 202, other sensors) as described herein regarding FIGS. 1-9. The host system 1000 can be any system requiring smart sensors, such as feature phones, smartphones, smart watches, tablets, eReaders, netbooks, automotive navigation devices, gaming consoles or devices, wearable computing devices, and so on.

While various embodiments of a smart sensor (e.g., comprising one or more of MEMS acoustic sensor or microphone 102, MEMS motion sensor 202, other sensors) according to aspects of the subject disclosure have been described herein for purposes of illustration, and not limitation, it can be appreciated that the subject disclosure is not so limited. Various implementations can be applied to other areas of MEMS sensor design and packaging, without departing from the subject matter described herein. For instance, it can be appreciated that other applications requiring smart sensors as described can include remote monitoring and/or sensing devices, whether autonomous or semi-autonomous, and whether or not such remote monitoring and/or sensing devices involve applications employing a acoustic sensor or microphone. For instance, various techniques, as described herein, employing a DSP within a sensor package can facilitate improved power management and battery life for a single charge by providing, for example, more intelligent and/or discriminating recognition of trigger events or wake events. As a result, other embodiments or applications of smart sensors can include, but are not limited to, applications involving sensors associated with measuring temperature, pressure, humidity, light, and/or other electromagnetic radiation (e.g., such as communication signals), and/or other sensors associated with measuring other physical, chemical, or electrical phenomena.

Accordingly, in various aspects, the subject disclosure provides a sensor comprising a MEMS acoustic sensor (e.g., MEMS acoustic sensor or microphone 102) having or associated with a back cavity (e.g., back cavity 306), for example, regarding FIGS. 1-10. In a further exemplary embodiment, as described above regarding FIGS. 1 and 2, for example, the sensor can be configured to operate at a voltage below 1.5 volts. In a further aspect, the sensor can be configured to operate in an always-on mode, as described herein. For example, the sensor can be included in a device such as host system 1000 (e.g., a feature phone, smartphone, smart watch, tablet, eReader, netbook, automotive navigation device, gaming console or device, wearable computing device) comprising a system processor (e.g., device 1010), wherein the system processor (e.g., device 1010) is located outside the package. For example, system processor (e.g., device 1010) can include an integrated circuit (IC) for controlling functionality of a mobile phone (e.g., host system 1000).

The sensor can further comprise a DSP (e.g., DSP 106/212), located in the back cavity (e.g., back cavity 306), which DSP can be configured to generate a control signal (e.g., control signal 104/204) for the system processor (e.g., device 1010 communicably coupled with the sensor) in response to receiving a signal from the MEMS acoustic sensor (e.g., MEMS acoustic sensor or microphone 102). In addition, the sensor can comprise a package that can include a lid (e.g., lid 304) and a package substrate (e.g., sensor or microphone package substrate 302), for example, as described above regarding FIGS. 3-9. In an aspect, the package can have a port (e.g., port 308) that can be adapted to receive acoustic waves or acoustic pressure. In a further aspect, the package can house the MEMS acoustic sensor (e.g., sensor or microphone package substrate 302) and can define the back cavity (e.g., back cavity 306) of the MEMS acoustic sensor (e.g., sensor or microphone package substrate 302). In another non-limiting aspect, the sensor can further comprise a MEMS motion sensor (e.g., MEMS motion sensor 202).

The DSP (e.g., DSP 106/212) can comprise an ASIC, for instance, as described above. In a further aspect the DSP (e.g., DSP 106/212) can be configured to generate a wake-up signal in response to processing the signal from the MEMS acoustic sensor (e.g., MEMS acoustic sensor or microphone 102, MEMS motion sensor 202). As a result, the DSP (e.g., DSP 106/212) can comprise a wake-up module configured to wake up the system processor (e.g., device 1010) according to a trigger event or wake event, as recognized and/or inferred by DSP (e.g., DSP 106/212). In a further non-limiting aspect, the DSP (e.g., DSP 106/212) can be configured to generate the control signal 104/204 in response to receiving one or more of a signal from the MEMS motion sensor (e.g., MEMS motion sensor 202) or the signal from the MEMS acoustic sensor (e.g., MEMS acoustic sensor or microphone 102), a signal from other sensors, a signal from other devices are processors such as the system processor (e.g., device 1010), and so on.

In addition, the DSP (e.g., DSP 106/212) can be further configured to, or can comprise a sensor control module configured to, control one or more of the MEMS motion sensor (e.g., MEMS motion sensor 202), the MEMS acoustic sensor (e.g., MEMS acoustic sensor or microphone 102), etc., for example, as further described above regarding FIGS. 1-2. For instance, a sensor control module as described herein can be configured to perform self-contained functions (e.g., calibration, performance adjustment, change operation modes) guided by self-sufficient analysis of a signal from the one or more MEMS sensors (e.g., a signal from one or more of the MEMS acoustic sensor or microphone 102, the MEMS motion sensor 202, another sensor, etc., other signals from sensors associated with the DSP (e.g., DSP 106/212), other signals from external device or system processor (e.g., device 1010), and/or any combination thereof). Thus, in a further non-limiting aspect, the DSP (e.g., DSP 106/212), comprising the sensor control module, for example, can be configured to perform such sensor control functions, for example, in response to receiving one or more of a signal from the MEMS motion sensor (e.g., MEMS motion sensor 202) or the signal from the MEMS acoustic sensor (e.g., MEMS acoustic sensor or microphone 102), a signal from other sensors, a signal from other devices are processors such as the system processor (e.g., device 1010), and so on. Accordingly, DSP (e.g., DSP 106/212), or a sensor control module associated with DSP (e.g., DSP 106/212), can be configured to, among other things, calibrate, adjust performance of, or change operating mode of one or more of the MEMS acoustic sensor (e.g., MEMS acoustic sensor or microphone 102), the MEMS motion sensor (e.g., MEMS motion sensor 202), another sensor, etc.

However, various exemplary implementations of the sensor as described can additionally, or alternatively, include other features or functionality of sensors, smart sensors, microphones, sensors or microphone packages, and so on, as further detailed herein, for example, regarding FIGS. 1-10.

In further exemplary embodiments, the subject disclosure provides a microphone package (e.g., a sensor or microphone package comprising a MEMS acoustic sensor or microphone 102), for example, as further described above regarding FIGS. 1-10. In a further exemplary embodiment, as described above regarding FIGS. 1 and 2, for example, the microphone package can be configured to operate at a voltage below 1.5 volts. In a further aspect, the microphone package can be configured to operate in an always-on mode, as described herein. For example, the microphone package can be included in a device or system such as host system 1000 (e.g., a feature phone, smartphone, smart watch, tablet, eReader, netbook, automotive navigation device, gaming console or device, wearable computing device) comprising a system processor (e.g., device 1010), wherein the system processor (e.g., device 1010) is located outside the package. For example, system processor (e.g., device 1010) can include an integrated circuit (IC) for controlling functionality of a mobile phone (e.g., host system 1000).

Accordingly, a microphone package (e.g., a sensor or microphone package comprising a MEMS acoustic sensor or microphone 102) can comprise a MEMS microphone (e.g., MEMS acoustic sensor or microphone 102) having or associated with a back cavity (e.g., back cavity 306). The microphone package can further comprise a DSP (e.g., DSP 106/212), located in the back cavity (e.g., back cavity 306), which DSP can be configured to control a device (e.g., device 1010) external to the microphone package via a control signal (e.g., control signal 104/204). For instance, the microphone package can comprise a lid (e.g., lid 304) and a package substrate (e.g., sensor or microphone package substrate 302), for example, as described above regarding FIGS. 3-9. In an aspect, the microphone package can have a port (e.g., port 308) that can be adapted to receive acoustic waves or acoustic pressure. In a further aspect, the microphone package defines the back cavity (e.g., back cavity 306). In another aspect, the microphone package can house the MEMS microphone (e.g., sensor or microphone package substrate 302) and the DSP (e.g., DSP 106/212). In another non-limiting aspect, the microphone package can further comprise a MEMS motion sensor (e.g., MEMS motion sensor 202).

The DSP (e.g., DSP 106/212) can comprise an ASIC, for instance, as described above. In a further aspect the DSP (e.g., DSP 106/212) can be configured to generate a wake-up signal in response to processing the signal from the MEMS microphone (e.g., MEMS acoustic sensor or microphone 102, MEMS motion sensor 202). As a result, the DSP (e.g., DSP 106/212) can comprise a wake-up component configured to wake up the device (e.g., device 1010) according to a trigger event or wake event, as recognized and/or inferred by DSP (e.g., DSP 106/212). In a further non-limiting aspect, the DSP (e.g., DSP 106/212) can be configured to generate the control signal 104/204 in response to receiving one or more of a signal from the MEMS motion sensor (e.g., MEMS motion sensor 202) or the signal from the MEMS microphone (e.g., MEMS acoustic sensor or microphone 102), a signal from other sensors, a signal from other devices are processors such as the device (e.g., device 1010), and so on.

In addition, the DSP (e.g., DSP 106/212) can further comprise a sensor control component configured to control one or more of the MEMS motion sensor (e.g., MEMS motion sensor 202), the MEMS microphone (e.g., MEMS acoustic sensor or microphone 102), etc., for example, as further described above regarding FIGS. 1-2. For instance, a sensor control component as described herein can be configured to perform self-contained functions (e.g., calibration, performance adjustment, change operation modes) guided by self-sufficient analysis of a signal from the one or more MEMS sensors (e.g., a signal from one or more of the MEMS acoustic sensor or microphone 102, the MEMS motion sensor 202, another sensor, etc., other signals from sensors associated with the DSP (e.g., DSP 106/212), other signals from external device or system processor (e.g., device 1010), and/or any combination thereof). Thus, in a further non-limiting aspect, the DSP (e.g., DSP 106/212) comprising the sensor control component can be configured to perform such sensor control functions, for example, in response to receiving one or more of a signal from the MEMS motion sensor (e.g., MEMS motion sensor 202) or the signal from the MEMS microphone (e.g., MEMS acoustic sensor or microphone 102), a signal from other sensors, a signal from other devices are processors such as the system processor (e.g., device 1010), and so on. Accordingly, a sensor control component associated with DSP (e.g., DSP 106/212) can be configured to, among other things, calibrate, adjust performance of, or change operating mode of one or more of the MEMS microphone (e.g., MEMS acoustic sensor or microphone 102), the MEMS motion sensor (e.g., MEMS motion sensor 202), another sensor, etc.

However, various exemplary implementations of the sensor as described can additionally, or alternatively, include other features or functionality of sensors, smart sensors, microphones, sensors or microphone packages, and so on, as further detailed herein, for example, regarding FIGS. 1-10.

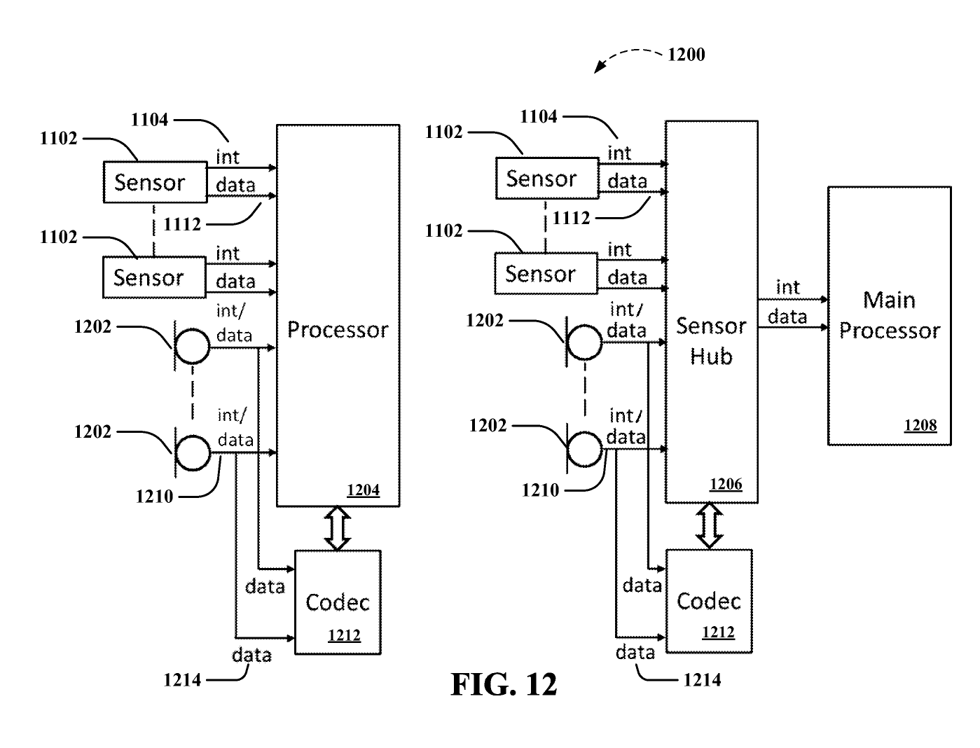

As non-limiting examples, FIGS. 12-15 depict further non-limiting aspects of exemplary implementations of sensors, smart sensors, microphones, sensors or microphone packages, and so on, as further detailed herein.

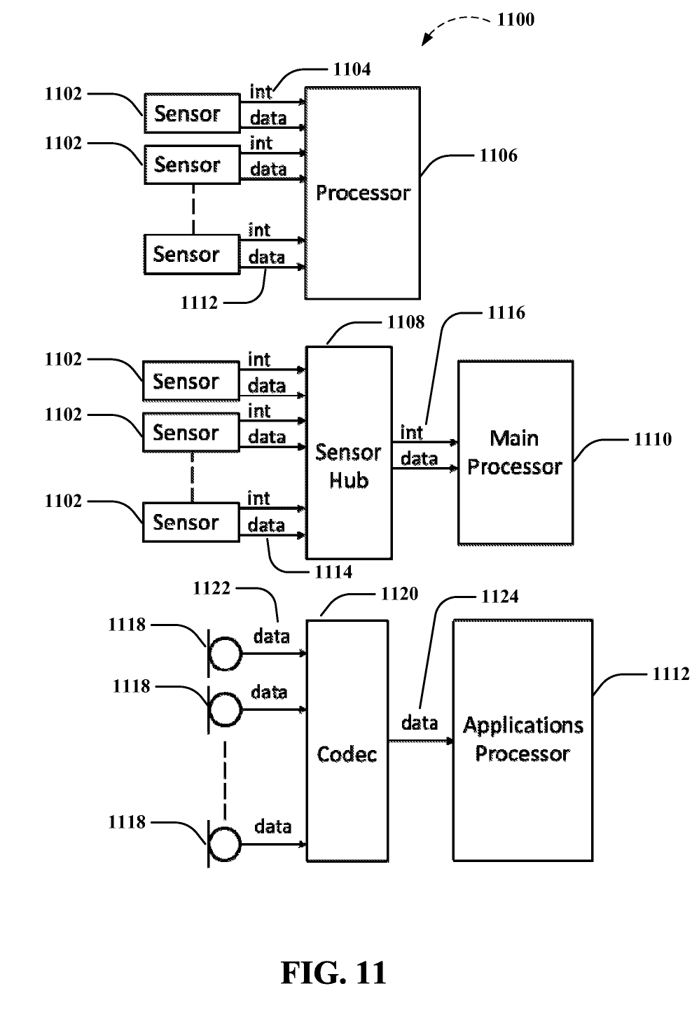

FIG. 11 depicts exemplary operating environments 1100 suitable for incorporation of exemplary embodiments of the subject disclosure. For example, it can be understood that sensors 1102 in many conventional applications may include digital circuitry (not shown) that facilitates generating control signals 1104 (e.g., interrupt signals, interrupt control signals, I²C signals) signal upon occurrence of some event. The control signals 1104 (e.g., interrupt signals, interrupt control signals, I²C signals) may be sent to a processor (e.g., processor 1106, sensor hub 1108, main processor 1110, applications processor 1112, etc.) to inform it of the existence of useful information in the sensor 1102 and the need for communication between sensor 1102 and processor (e.g., processor 1106, sensor hub 1108, main processor 1110, applications processor 1112, etc.). As depicted in FIG. 11, in addition to a processor comprising processor 1106, sensor hub 1108, and/or main processor 1110, a processor according to a non-limiting aspect can comprise an applications processor 1112 (AP), for example, in a mobile device or platform, such as a cellular phone or a tablet personal computer (PC), without limitation.

As further depicted in FIG. 11, exemplary operating environments 1100 can comprise systems employing a layered architecture in which sensors 1102 send a control signal 1104 (e.g., interrupt signal, interrupt control signal, I²C signal) to a sensor hub (e.g., sensor hub 1108), which can comprise a smaller and less power-intensive processor than the main processor (e.g., main processor 1110) in the system (e.g., an AP, etc.). An exemplary sensor hub (e.g., sensor hub 1108) can facilitate performing a certain level of signal processing on data 1114 received from the sensors 1102, while an exemplary main processor (e.g., main processor 1110) can be maintained in a reduced power mode (e.g., a sleep mode, etc.) to reduce the power consumption of the system.

Subsequently, an exemplary sensor hub (e.g., sensor hub 1108) may determine (e.g., based on data comprising information associated with the sensor 1102, etc.) to send a control signal 1116 (e.g., interrupt signal, interrupt control signal, I²C signal) to an exemplary main processor (e.g., main processor 1110). Based at least in part on the control signal 1116 (e.g., interrupt signal, interrupt control signal, I²C signal), the main processor (e.g., main processor 1110) can facilitate determining whether to power up (e.g., wake up from a reduced power sleep mode) components of an exemplary system, which can facilitate communication between an exemplary sensor hub (e.g., sensor hub 1108) and an exemplary main processor (e.g., main processor 1110).

As further depicted in FIG. 11, exemplary operating environments 1100 can comprise systems, such as a cellular phone, a tablet PC, etc., comprising one or more microphones 1118. It can be understood that in exemplary operating environments 1100 a Codec 1120 can be employed for one or more of controlling microphones 1118, receiving audio data 1122 from microphones 1118, and/or sending the processed audio data 1124 to an exemplary main processor (e.g., applications processor 1112). In such systems, an exemplary main processor (e.g., applications processor 1112) can facilitate determining whether to power up (e.g., wake up from a reduced power sleep mode) components of an exemplary system such as Codec 1120 and/or instruct the Codec 1120 to turn on the microphones 1118.

Once the microphones 1118 are turned on, microphones 1118 can continuously send audio data 1122 to the Codec 1120. It can be understood that such conventional configurations can consume excessive power while the microphones 1118 are continuously powered on. For instance, it can be further understood that, to maintain even minimal functionality, the microphones 1118, Codec 1120, and the main processor (e.g., applications processor 1112) are continuously powered. By comparison with the other exemplary interrupt-based operating environments for sensors 1102, it is apparent that conventional audio systems employing microphones 1118 are not as power-efficient. However, because microphones 1118 comprise audio sensors that operate on acoustic signals, exemplary embodiments of the subject disclosure can facilitate generating control signals (e.g., interrupt signals, interrupt control signals, I²C signals). Moreover, exemplary embodiments of the subject disclosure can facilitate always-on operation of microphones for applications such as sound detection, voice activity detection, keyword spotting, ambient sound analysis, etc., for example, by employing acoustic sensors that can facilitate generating control signals (e.g., interrupt signals, interrupt control signals, I²C signals) for transmission to an exemplary processor (e.g., processor 1106, sensor hub 1108, main processor 1110, applications processor 1112, etc.) based on detection of an acoustic event.

FIG. 12 depicts exemplary embodiments 1200 comprising smart sensors 1202 that facilitate generating control signals according to non-limiting aspects of the subject disclosure. For example, FIG. 12 depicts exemplary embodiments 1200 employing acoustic sensors 1202 that can facilitate generating control signals (e.g., interrupt signals, interrupt control signals, I²C signals) for transmission to an exemplary processor (e.g., processor 1204, sensor hub 1206, main processor 1208, an exemplary applications processor, etc.) based on detection of an acoustic event. In exemplary embodiments, the generated control signal can be transmitted via a multiplexed output signal 1210 comprising one or more exemplary control signals (e.g., interrupt signals, interrupt control signals, I²C signals) and data comprising a signal associated with sound pressure waves transduced by an exemplary acoustic sensor 1202.

As a non-limiting example, regarding acoustic sensor 1202 and an exemplary processor (e.g., processor 1204), upon detection of an acoustic event and/or determining whether the acoustic event represents a valid acoustic event, acoustic sensor 1202 can generate a control signal (e.g., interrupt signal, interrupt control signal, I²C signal) and transmit it to an exemplary processor (e.g., processor 1204). Based on the processor interrupt, an exemplary processor (e.g., processor 1204) can facilitate determining whether to power up (e.g., wake up from a reduced power sleep mode) and/or whether to initiate communication with acoustic sensor 1202. In some exemplary embodiments 1200 comprising a Codec 1212, acoustic sensor 1202 can facilitate simultaneously transmitting audio data 1214 to the Codec 1212.

As a further non-limiting example, regarding acoustic sensor 1202 and an exemplary processor (e.g., main processor 1208), upon detection of an acoustic event and/or determining whether the acoustic event represents a valid acoustic event, acoustic sensor 1202 can generate a control signal (e.g., interrupt signal, interrupt control signal, I²C signal) and transmit it to an exemplary sensor hub (e.g., sensor hub 1206). Based on an interrupt transmitted to an exemplary sensor hub (e.g., sensor hub 1206), exemplary sensor hub (e.g., sensor hub 1206) can facilitate determining whether to power up (e.g., wake up from a reduced power sleep mode) and/or whether to initiate communication with acoustic sensor 1202, such as by requesting and/or receiving audio data 1214 from acoustic sensor 1202. In some exemplary embodiments 1200 comprising a Codec 1212, acoustic sensor 1202 can facilitate simultaneously transmitting audio data 1214 to the Codec 1212. In further embodiments, an exemplary sensor hub (e.g., sensor hub 1206), upon receiving audio data 1214 (e.g., via a multiplexed output signal 1210 comprising one or more exemplary control signals (e.g., interrupt signals, interrupt control signals, I²C signals) and data comprising a signal associated with sound pressure waves transduced by an exemplary acoustic sensor 1202) and/or determining whether the audio data 1214 represents valid audio data, exemplary sensor hub (e.g., sensor hub 1206) can facilitate determining whether to power up (e.g., wake up from a reduced power sleep mode) components of an exemplary system, such as an exemplary processor (e.g., main processor 1208), for example, or whether to power down (e.g., return components to a reduced power sleep mode, an event detection mode, etc.).

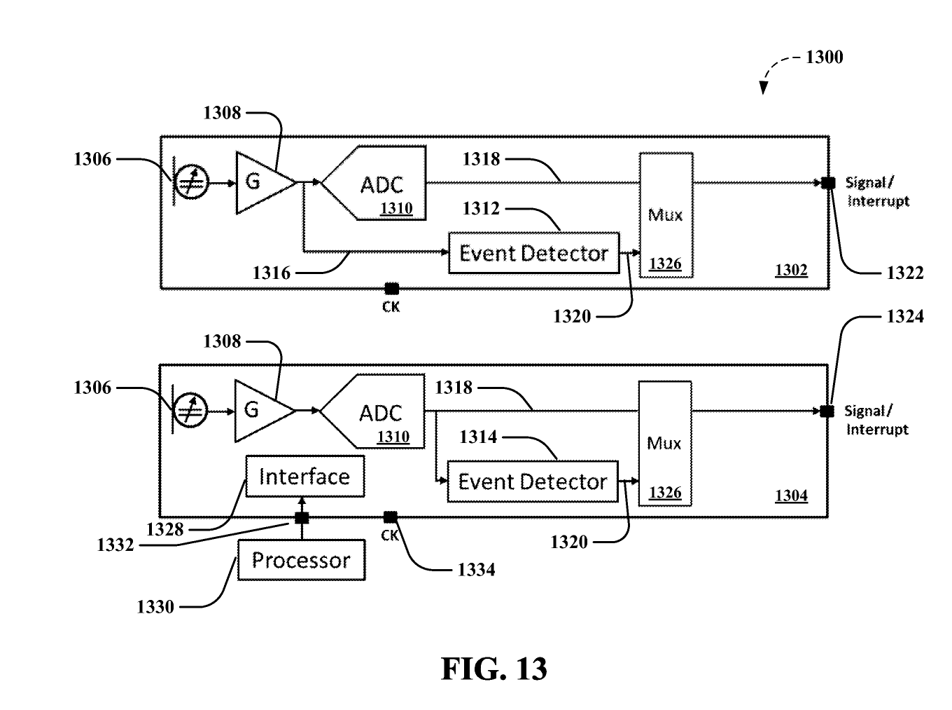

FIG. 13 depicts further exemplary embodiments 1300 of smart sensors 1302, 1304 that facilitate generating control signals according to the subject disclosure. As used herein, reference to sensors, smart sensors, and the like, as well as packages comprising sensors, smart sensors, etc., refer to MEMS sensors, MEMS smart sensors, etc., unless specified otherwise. For instance, an exemplary MEMS acoustic sensor or microphone 1306 can comprise an acoustic membrane (not shown) and an ASIC configured to process signals associated with sound pressure waves received by the membrane, for example, as further described herein, regarding FIGS. 3-9. An exemplary ASIC can include a pre-amplifier 1308 configured to generate an analog signal 1316 associated with sound pressure waves received by exemplary MEMS acoustic sensor or microphone 1306 and/or can include an ADC 1310 to generate a digital signal 1318 associated with sound pressure waves received by exemplary MEMS acoustic sensor or microphone 1306 (e.g., a digital audio signal a PDM signal, an I²S signals, information, and/or data in another digital format), etc.

Non-limiting embodiments of the subject disclosure can comprise additional circuitry, such as an event detector 1312, 1314, an event detection component, and so on, which can be configured to determine, based on analog signal 1316 associated with sound pressure waves, based on the digital signal 1318 associated with sound pressure waves, and so on, whether to generate one or more exemplary control signals 1320 (e.g., interrupt signals, interrupt control signals, I²C signals). For instance, an exemplary event detector 1312, 1314, an event detection component, and so on, can be configured to detect a sound pressure event based on a signal (e.g., an analog signal 1316, a digital signal 1318) associated with the sound pressure waves and/or generate one or more exemplary control signals 1320 (e.g., interrupt signals, interrupt control signals, I²C signals) in response to receiving the signal (e.g., an analog signal 1316, a digital signal 1318) associated with the sound pressure waves from the MEMS acoustic sensor or microphone 1306. In non-limiting aspects, an exemplary event detector 1312, 1314, an event detection component, and so on, can be configured to detect any of a variety of sound pressure events, comprising or associated with a sound, a human voice, an ultrasonic signal, a keyword, a voice activity, or a predefined sound pattern as the sound pressure event, and so on, without limitation.

In addition, exemplary embodiments of the subject disclosure can comprise additional circuitry that facilitates combining and/or transmitting one or more exemplary control signals 1320 (e.g., interrupt signals, interrupt control signals, I²C signals) and data comprising a signal (e.g., an analog signal 1316, a digital signal 1318) associated with sound pressure waves transduced by an exemplary MEMS acoustic sensor or microphone 1306 on a single output (e.g., a solder pad, a pin, a contact, etc., associated with signal/interrupt output 1322, 1324) of a package (e.g., package comprising smart sensor 1302, 1304, etc.), for example, as further described herein, regarding FIGS. 3-9. As a non-limiting example, FIG. 13 depicts a multiplexer (MUX) 1326 configured to combine and/or transmit one or more exemplary control signals 1320 (e.g., interrupt signals, interrupt control signals, I²C signals) and data comprising a signal (e.g., an analog signal 1316, a digital signal 1318) associated with sound pressure waves transduced by an exemplary MEMS acoustic sensor or microphone 1306 on a single output (e.g., a solder pad, a pin, a contact, etc., associated with signal/interrupt output 1322, 1324) of a package (e.g., package comprising smart sensor 1302, 1304, etc.), for example, as further described herein, regarding FIGS. 3-9.

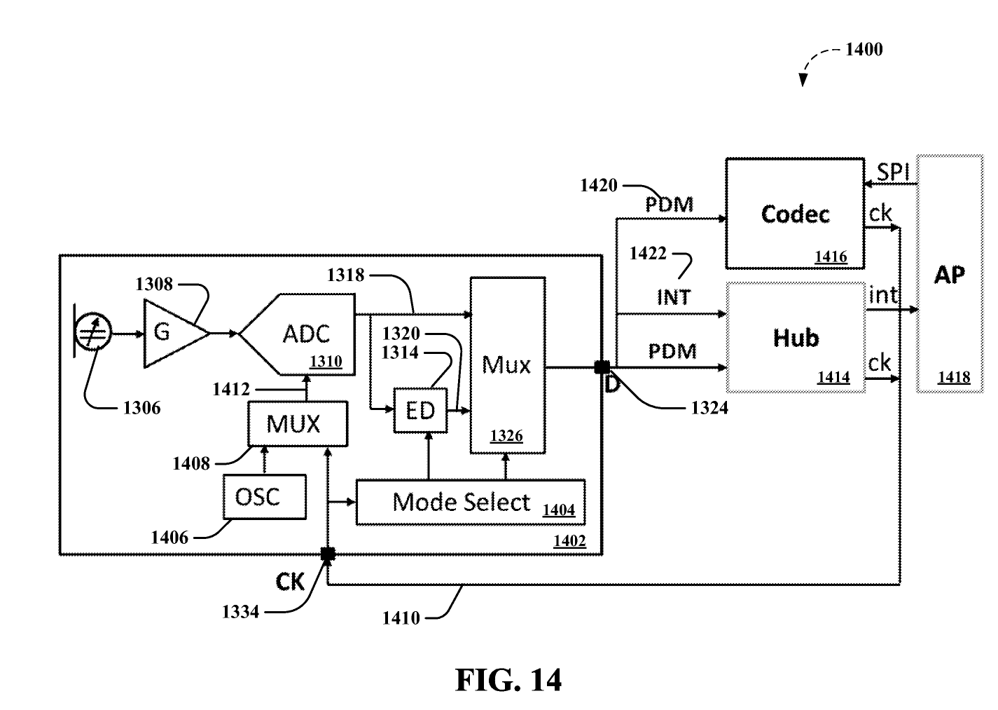

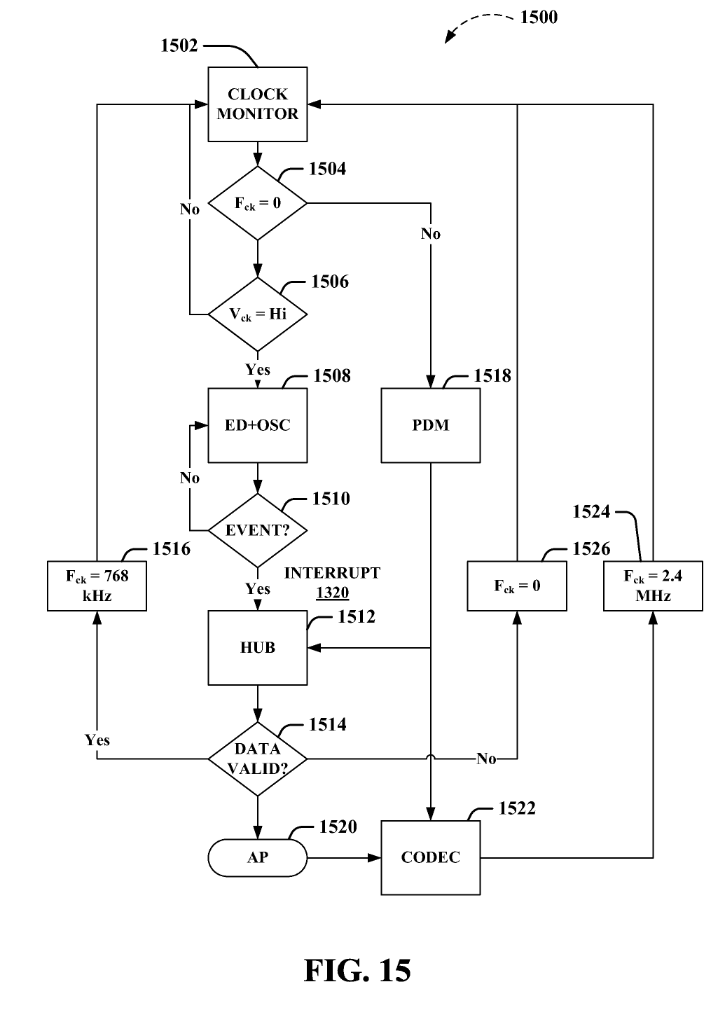

In other exemplary embodiments of the subject disclosure, embodiments 1300 of smart sensors (e.g., smart sensor 1304, etc.) can further comprise additional circuitry that facilitates operating exemplary smart sensors comprising MEMS acoustic sensor or microphone 1306 in various modes in addition to a standard performance mode. As non-limiting examples, exemplary embodiments 1300 of smart sensors (e.g., smart sensor 1304, etc.) can facilitate operating smart sensors (e.g., smart sensor 1304, etc.) in an event detection mode, a low-power audio mode, a standard-performance mode, an ultrasonic mode, and/or a sleep mode, without limitation, for example, as further described herein, regarding a mode selection component and FIGS. 14-15. In still other exemplary embodiments of the subject disclosure, embodiments 1300 of smart sensors (e.g., smart sensor 1304, etc.) can further comprise additional circuitry that facilitates providing a mode selection interface through which a processor 1330 (e.g., processor, sensor hub, main processor, applications processor, etc.) can facilitate changing from between the various modes of operation of the exemplary embodiments 1300 of smart sensors (e.g., smart sensor 1304, etc.) comprising MEMS acoustic sensor or microphone 1306, for example, as further described herein, regarding a mode selection component and FIGS. 14-15.

In non-limiting aspects, various embodiments of the subject disclosure can provide a mode selection interface 1328 configured according to a standard such as I²C, serial peripheral interface (SPI), Mobile Industry Processor Interface® (MIPI) SoundWire^{SM}, and/or another custom interface. In addition, while FIG. 13 depicts processor 1330 (e.g., processor, sensor hub, main processor, applications processor, etc.) coupled to mode selection interface 1328, via a mode select input 1332 (e.g., a solder pad, a pin, a contact, etc.) of a package (e.g., package comprising smart sensor 1302, 1304, etc.), processor 1330 (e.g., processor, sensor hub, main processor, applications processor, etc.) can also be coupled to another input such as a clock (ck) input 1334 (e.g., a solder pad, a pin, a contact, etc.), for example, as further described herein, regarding a mode selection component and FIGS. 14-15.

For instance, FIG. 14 depicts exemplary systems 1400 comprising a smart sensor (e.g., smart sensor 1402, etc.) that facilitate generating control signals 1320 (e.g., interrupt signals, interrupt control signals, I²C signals) according to further aspects the subject disclosure. In addition to exemplary components depicted in FIG. 13 regarding exemplary smart sensors (e.g., smart sensor 1304, etc.), exemplary smart sensor 1402 can further comprise additional circuitry that facilitates operating exemplary smart sensors comprising MEMS acoustic sensor or microphone 1306 in various modes in addition to a standard performance mode. As a non-limiting example, various embodiments of the subject disclosure can provide a mode selection interface comprising a mode selection component 1404 configured to set one mode from between several modes of the exemplary smart sensor 1402 comprising one or more of an event detection mode, a low-power audio mode, a standard-performance mode, an ultrasonic mode, or a sleep mode, as further described above.

In a further non-limiting example, exemplary embodiments of a mode selection component 1404 can further comprise a clock monitor component (not shown) configured to monitor the status of a clock (ck) input 1334 (e.g., a solder pad, a pin, a contact, etc.) to facilitate providing a mode selection interface 1328. For example, as further described herein, an exemplary control interface can be provided for exemplary smart sensor 1402, for example, employing the status of a clock (ck) input 1334 (e.g., a solder pad, a pin, a contact, etc.) as an indicator and/or control of a selected mode of operation for the exemplary smart sensor 1402 comprising MEMS acoustic sensor or microphone 1306. In an exemplary embodiment, exemplary smart sensor 1402 can further comprise an internal oscillator (OSC) 1406 that facilitates generation of a clock signal for operation of exemplary smart sensor 1402 comprising MEMS acoustic sensor or microphone 1306 in an event detection mode of operation. As depicted in FIG. 14, exemplary embodiments can further comprise a multiplexer 1408 configured to combine a clock signal from internal oscillator (OSC) 1406 and an external clock signal 1410 and/or manage the clock signal 1412 employed by components of the exemplary smart sensor 1402 comprising MEMS acoustic sensor or microphone 1306 facilitate providing a mode selection interface 1328 while maintaining stability of the clock signal 1412 and associated control signals 1320 (e.g., interrupt signals, interrupt control signals, I²C signals) and data comprising a signal (e.g., an analog signal (not shown), a digital signal 1318) associated with sound pressure waves transduced by an exemplary MEMS acoustic sensor or microphone 1306.

It can be understood that, by combining and/or transmitting one or more exemplary control signals 1320 (e.g., interrupt signals, interrupt control signals, I²C signals) and data comprising a signal (e.g., an analog signal 1316 (not shown), a digital signal 1318) associated with sound pressure waves transduced by an exemplary MEMS acoustic sensor or microphone 1306 on a single output (e.g., a solder pad, a pin, a contact, etc., associated with signal/interrupt output 1324) of a package (e.g., package comprising smart sensor 1402, etc.), exemplary embodiments can provide smart sensors incorporating exemplary interrupt generation mechanisms of the subject disclosure with the same number of pins as in conventional digital PDM microphones (e.g., exemplary embodiments of smart sensors are pin-compatible with a conventional digital microphones that include five inputs/outputs or pins (e.g., clock, data, L/R, Supply, ground inputs/outputs or pins)).

Accordingly, exemplary systems 1400 comprising a smart sensor (e.g., smart sensor 1402, etc.) that facilitate generating control signals 1320 (e.g., interrupt signals, interrupt control signals, I²C signals), upon detection of an acoustic event and/or determining whether the acoustic event represents a valid acoustic event, exemplary smart sensor 1402 comprising MEMS acoustic sensor or microphone 1306 can generate a control signal 1320 (e.g., interrupt signal, interrupt control signal, I²C signal) and transmit it to an exemplary sensor hub (e.g., sensor hub 1414). Based on an interrupt transmitted to an exemplary sensor hub (e.g., sensor hub 1414), exemplary sensor hub (e.g., sensor hub 1414) can facilitate determining whether to power up (e.g., wake up from a reduced power sleep mode) and/or whether to initiate communication with exemplary smart sensor 1402 comprising MEMS acoustic sensor or microphone 1306, such as by requesting and/or receiving data comprising a signal (e.g., an analog signal (not shown), a digital signal 1318) from exemplary smart sensor 1402 comprising MEMS acoustic sensor or microphone 1306.

In some exemplary embodiments 1400 comprising a Codec 1416, exemplary smart sensor 1402 comprising MEMS acoustic sensor or microphone 1306 can facilitate simultaneously transmitting data comprising a signal (e.g., an analog signal (not shown), a digital signal 1318) to the Codec 1416. In further embodiments, an exemplary sensor hub (e.g., sensor hub 1414), upon receiving data comprising a signal (e.g., an analog signal (not shown), a digital signal 1318), e.g., via a multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318) and/or determining whether the data comprising a signal (e.g., an analog signal (not shown), a digital signal 1318) represents valid audio data, exemplary sensor hub (e.g., sensor hub 1414) can facilitate determining whether to power up (e.g., wake up from a reduced power sleep mode) components of an exemplary system 1400, such as an exemplary processor (e.g., application processor 1418), for example, or whether to power down (e.g., return components to a reduced power sleep mode, an event detection mode, etc.).

FIG. 15 depicts an exemplary schema 1500 for event detection, generation of one or more exemplary control signals 1320 (e.g., interrupt signals, interrupt control signals, I²C signals), and/or mode selection according to non-limiting aspects of the subject disclosure. As described above, exemplary embodiments of a mode selection component 1404 can further comprise a clock monitor component (not shown) configured to monitor the status of a clock (ck) input 1334. Thus, at 1502, an exemplary clock monitor component (not shown) monitoring the status of a clock (ck) input 1334 can determine one or more of frequency (F_{ck}) and/or voltage (V_{ck}) of any signal on the clock (ck) input 1334. For instance, in an exemplary schema 1500, if it is determined that the clock (ck) input 1334 is held continuously low (e.g., F_{ck}=0 at 1504 and V_{ck} does not equal a logical high-value at 1506), an exemplary smart sensor 1402 comprising MEMS acoustic sensor or microphone 1306 can be placed in a sleep mode (e.g., via mode selection component 1404, etc.), for which clock monitoring can continue at 1502.

If it is determined, at 1506, that the clock (ck) input 1334 is steadily held at logical high (e.g., V_{ck} equals a logical high-value at 1506), exemplary smart sensor 1402 comprising MEMS acoustic sensor or microphone 1306 can be placed in an event detection mode (e.g., via mode selection component 1404, etc.). In an exemplary event detection mode, an external processor (e.g., application processor 1418 and/or sensor hub 1414) as well as Codec 1414 can be placed in an exemplary sleep mode while holding clock (ck) input 1334, e.g., V_{ck}, at a logical high-value. Note that, in exemplary embodiments, in the absence of the external clock e.g., external clock signal 1410), exemplary smart sensor 1402 comprising MEMS acoustic sensor or microphone 1306 can switch to internal oscillator (OSC) 1406, at 1508, to operate ADC 1310 and/or other components such as, for example, mode selection interface 1328, event detector 1314, etc.

Upon detection of an acoustic event (e.g., via , at 1510, exemplary smart sensor 1402 comprising MEMS acoustic sensor or microphone 1306 can generate a control signal 1320 (e.g., interrupt signal, interrupt control signal, I²C signal) and can transmit it to an exemplary sensor hub (e.g., sensor hub 1414) at 1512. As further described herein, the control signal 1320 (e.g., interrupt signal, interrupt control signal, I²C signal) can be routed to an exemplary sensor hub (e.g., sensor hub 1414) via a multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318). In exemplary embodiments, the multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318) can be can be controlled by an exemplary mode selection component (e.g., mode selection component 1404) configured to control one or more of multiplexer (MUX) 1326, an exemplary internal oscillator (OSC) 1406, and/or an exemplary multiplexer 1408 to facilitate executing exemplary schema 1500 for event detection, generation of one or more exemplary control signals 1320 (e.g., interrupt signals, interrupt control signals, I²C signals), and/or mode selection according to non-limiting aspects of the subject disclosure.

If no event is detected at 1510, exemplary smart sensor 1402 comprising MEMS acoustic sensor or microphone 1306 can remain in an exemplary event detection mode (e.g., via mode selection component 1404, etc.) at 1508. For instance, in an exemplary event detection mode, an exemplary sensor hub (e.g., sensor hub 1414) and an exemplary Codec (e.g., Codec 1416) can be maintained in an exemplary sleep mode, for which exemplary sensor hub (e.g., sensor hub 1414) and exemplary Codec (e.g., Codec 1416) can remain unresponsive to any signal on their data input (e.g., PDM input 1420). However, if an event is detected at 1510, exemplary smart sensor 1402 comprising MEMS acoustic sensor or microphone 1306 can facilitate generating control signals 1320 (e.g., interrupt signals, interrupt control signals, I²C signals) and/or transmitting them to exemplary sensor hub (e.g., sensor hub 1414) via the interrupt pin 1422 of the exemplary sensor hub (e.g., sensor hub 1414), because exemplary smart sensor 1402 comprising MEMS acoustic sensor or microphone 1306 is connected to exemplary sensor hub (e.g., sensor hub 1414) via multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318). Thus, control signals 1320 (e.g., interrupt signals, interrupt control signals, I²C signals) received at exemplary sensor hub (e.g., sensor hub 1414), at 1512, can be employed as a signal that facilitates instructing exemplary sensor hub (e.g., sensor hub 1414) to power up (e.g., wake up from a reduced power sleep mode).

Upon receiving control signals 1320 (e.g., interrupt signals, interrupt control signals, I²C signals) at exemplary sensor hub (e.g., sensor hub 1414), at 1512, exemplary sensor hub (e.g., sensor hub 1414) can facilitate sending a low-frequency clock (e.g., F_{ck}=768 kHz) to exemplary smart sensor 1402 comprising MEMS acoustic sensor or microphone 1306 at 1516. Upon detecting a low-frequency clock (e.g., F_{ck}=768 kHz) on clock (ck) input 1334 (e.g., a solder pad, a pin, a contact, etc.) via an exemplary mode selection component 1404 comprising a clock monitor component (not shown) configured to monitor the status of a clock (ck) input 1334 (e.g., a solder pad, a pin, a contact, etc.), exemplary mode selection component 1404 can switch exemplary smart sensor 1402 comprising MEMS acoustic sensor or microphone 1306 from using the internal clock signal generated by internal oscillator (OSC) 1406 to external clock signal 1410 (e.g., comprising a low-frequency clock, such as, F_{ck}=768 kHz). As a result, exemplary mode selection component 1404 can switch exemplary smart sensor 1402 comprising MEMS acoustic sensor or microphone 1306, at 1504, from an exemplary event detection mode to an exemplary low-power audio mode at 1518. Because exemplary smart sensor 1402 comprising MEMS acoustic sensor or microphone 1306 is connected to exemplary sensor hub (e.g., sensor hub 1414) (and exemplary Codec (e.g., Codec 1416)) via multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318), exemplary smart sensor 1402 comprising MEMS acoustic sensor or microphone 1306 can transmit data comprising a signal (e.g., an analog signal (not shown), a digital signal 1318) associated with sound pressure waves transduced by an exemplary MEMS acoustic sensor or microphone 1306 to exemplary sensor hub (e.g., sensor hub 1414) (and exemplary Codec (e.g., Codec 1416)) at 1518.

In an exemplary embodiment, based on data comprising a signal (e.g., an analog signal (not shown), a digital signal 1318) associated with sound pressure waves received at exemplary sensor hub (e.g., sensor hub 1414), at 1512, exemplary sensor hub (e.g., sensor hub 1414) can facilitate determining whether an acoustic event represents a valid acoustic event, at 1514, as further described herein. Based on determining whether an acoustic event represents a valid acoustic event at 1514, exemplary sensor hub (e.g., sensor hub 1414) can facilitate determining whether to power up (e.g., wake up from a reduced power sleep mode) an exemplary processor (e.g., application processor 1418), at 1520. In turn, an exemplary processor (e.g., application processor 1418) can facilitate one or more of determining whether to power up (e.g., wake up from a reduced power sleep mode) an exemplary Codec (e.g., Codec 1416), at 1522, configuring an exemplary Codec (e.g., Codec 1416) to perform audio signal processing tasks in place of or in addition to an exemplary sensor hub (e.g., sensor hub 1414), at 1522, etc. If exemplary Codec (e.g., Codec 1416) to perform audio signal processing tasks in place of or in addition to an exemplary sensor hub (e.g., sensor hub 1414) at 1522, exemplary Codec (e.g., Codec 1416) can facilitate sending a higher-frequency clock (e.g., F_{ck}=2.4 MegaHertz (MHz)) on clock (ck) input 1334 (e.g., a solder pad, a pin, a contact, etc.) to exemplary smart sensor 1402 comprising MEMS acoustic sensor or microphone 1306 at 1524, while receiving data comprising a signal (e.g., an analog signal (not shown), a digital signal 1318) associated with sound pressure waves transduced by an exemplary MEMS acoustic sensor or microphone 1306 at exemplary Codec (e.g., Codec 1416), at 1522. Upon a higher-frequency clock (e.g., F_{ck}=2.4 MHz) on clock (ck) input 1334 (e.g., a solder pad, a pin, a contact, etc.) being provided, exemplary sensor hub (e.g., sensor hub 1414) can stop sending the low-frequency clock (e.g., F_{ck}=768 kHz). If it is determined that an acoustic event does not represent a valid acoustic event at 1514, exemplary sensor hub (e.g., sensor hub 1414) can facilitate determining whether exemplary smart sensor 1402 comprising MEMS acoustic sensor or microphone 1306 can remain in an exemplary event detection mode (e.g., via mode selection component 1404, etc.), at 1526, for example, by exemplary mode selection component 1404 switching exemplary smart sensor 1402 comprising MEMS acoustic sensor or microphone 1306 from using the external clock signal 1410 (e.g., comprising a low-frequency clock, such as, F_{ck}=768 kHz) to internal clock signal generated by internal oscillator (OSC) 1406.

Accordingly, in various embodiments, the subject disclosure can provide an exemplary MEMS acoustic sensor or microphone 1306 comprising an event detection circuit that facilitates generating an interrupt. For example, exemplary embodiments can comprise an exemplary smart sensor 1402 comprising MEMS acoustic sensor or microphone 1306, event detector 1312, 1314, an event detection component, and so on, that facilitates generating, via a multiplexed output (e.g., a solder pad, a pin, a contact, etc., associated with signal/interrupt output 1324) comprising one or more exemplary control signals 1320 (e.g., interrupt signals, interrupt control signals, I²C signals) and data comprising a signal (e.g., an analog signal (not shown), a digital signal 1318)) associated with sound pressure waves transduced by an exemplary MEMS acoustic sensor or microphone 1306. Other exemplary embodiments described herein can provide exemplary smart sensor 1402 comprising MEMS acoustic sensor or microphone 1306 and further comprising a clock monitor and a mode-select. In a further example, an exemplary smart sensor 1402 comprising MEMS acoustic sensor or microphone 1306 can further comprise an exemplary mode selection component 1404 comprising a clock monitor component (not shown) configured to monitor the status of a clock (ck) input 1334 (e.g., a solder pad, a pin, a contact, etc.), as further described herein.

In a non-limiting aspect, exemplary smart sensor 1402 comprising MEMS acoustic sensor or microphone 1306 can comprise an exemplary smart sensor 1402 comprising MEMS acoustic sensor or microphone 1306 that facilitates one or more of event detection and/or interrupt generation using conventional digital PDM microphones form factors (e.g., exemplary embodiments of smart sensors are pin-compatible with a conventional digital microphones that include five inputs/outputs or pins (e.g., clock, data, L/R, Supply, ground inputs/outputs or pins)). In further embodiments, subject disclosure provide exemplary systems comprising an exemplary processor (e.g., a processor, a main processor, an applications processor (e.g., application processor 1418), etc.), exemplary sensor hub (e.g., sensor hub 1414), an exemplary Codec (e.g., Codec 1416) and an exemplary smart sensor 1402 comprising MEMS acoustic sensor or microphone 1306 that facilitates one or more of event detection and/or interrupt generation.

In exemplary embodiments, the subject disclosure provides an exemplary sensor, comprising a MEMS acoustic sensor (e.g., MEMS acoustic sensor or microphone 1306) configured to process sound pressure waves in an event detection mode. The exemplary sensor can further comprise an event detection component (e.g., event detector 1312, 1314, an event detection component, and so on) comprising an ASIC configured to detect a sound pressure event associated with the sound pressure waves and generate a control signal (e.g., one or more exemplary control signals 1320, interrupt signals, interrupt control signals, I²C signals, etc.) in response to receiving a signal (e.g., an analog signal 1316, a digital signal 1318) associated with the sound pressure waves from the MEMS acoustic sensor (e.g., MEMS acoustic sensor or microphone 1306).

In another exemplary embodiment, an exemplary event detection component (e.g., event detector 1312, 1314, an event detection component, and so on) can be further configured to generate the control signal (e.g., one or more exemplary control signals 1320, interrupt signals, interrupt control signals, I²C signals, etc.) to wake up (e.g., wake up from a reduced power sleep mode) a Codec component (e.g., Codec 1416), a sensor hub (e.g., sensor hub 1414), or a system processor (e.g., a processor, a main processor, an applications processor (e.g., application processor 1418), etc.) associated with the sensor (e.g., comprising MEMS acoustic sensor or microphone 1306) from an exemplary low power mode in response to processing a multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves transduced by an exemplary MEMS acoustic sensor or microphone 1306) from the sensor (e.g., comprising MEMS acoustic sensor or microphone 1306). As further described herein, event detection component (e.g., event detector 1312, 1314, an event detection component, and so on) can be further configured to detect one or more of a sound, a human voice, an ultrasonic signal, a keyword, a voice activity, or a predefined sound pattern as a sound pressure event. In a non-limiting aspect, event detection component (e.g., event detector 1312, 1314, an event detection component, and so on) can be further configured to detect the sound pressure event associated with the sound pressure waves based on the signal (e.g., an analog signal 1316, a digital signal 1318) associated with the sound pressure waves transduced by an exemplary MEMS acoustic sensor or microphone 1306.

In exemplary embodiments, an exemplary sensor can further comprise a multiplexer (e.g., multiplexer 1326) configured to generate a multiplexed output signal (e.g., via signal/interrupt output 1322, 1324) in response to receiving the control signal (e.g., one or more exemplary control signals 1320, interrupt signals, interrupt control signals, I²C signals, etc.) and the signal (e.g., an analog signal 1316, a digital signal 1318) associated with the sound pressure waves. For instance, as further described herein, multiplexer 1326 can be configured to combine and/or transmit one or more exemplary control signals 1320 (e.g., interrupt signals, interrupt control signals, I²C signals) and data comprising a signal (e.g., an analog signal 1316, a digital signal 1318) associated with sound pressure waves transduced by an exemplary MEMS acoustic sensor or microphone 1306 as a multiplexed output signal on a single output (e.g., a solder pad, a pin, a contact, etc., associated with signal/interrupt output 1322, 1324) of a package (e.g., package comprising smart sensor 1302, 1304, 1402, etc.), for example, as further described herein, regarding FIGS. 3-9. Thus, an exemplary multiplexed output signal can comprise an interrupt comprising the control signal (e.g., one or more exemplary control signals 1320, interrupt signals, interrupt control signals, I²C signals, etc.) and data comprising the signal (e.g., an analog signal 1316, a digital signal 1318) associated with the sound pressure waves.

In further exemplary embodiments, an exemplary sensor can also comprise a package comprising a lid and a package substrate, wherein the package has a port adapted to receive the sound pressure waves and an output (e.g., a solder pad, a pin, a contact, etc., associated with signal/interrupt output 1322, 1324) adapted to transmit the multiplexed output signal, and wherein the package houses the MEMS acoustic sensor (e.g., exemplary MEMS acoustic sensor or microphone 1306), the multiplexer (e.g., multiplexer 1326), and the event detection component (e.g., event detector 1312, 1314, an event detection component, and so on), for example, as further described herein, regarding FIGS. 3-9.

In other exemplary embodiments, an exemplary sensor can also comprise a mode selection component (e.g., mode selection interface 1328, mode selection component 1404, etc.) configured to set one mode from between several modes of the sensor (e.g., comprising exemplary MEMS acoustic sensor or microphone 1306) comprising one or more of an exemplary event detection mode, an exemplary low-power audio mode, an exemplary standard-performance mode, an exemplary ultrasonic mode, or an exemplary sleep mode, as further described herein. In a non-limiting aspect, an exemplary mode selection component (e.g., mode selection interface 1328, mode selection component 1404, etc.) can be further configured to set one mode of the sensor (e.g., comprising exemplary MEMS acoustic sensor or microphone 1306) based in part on one, one or more of a signal on an interface (e.g., on a clock (ck) input 1334, on a mode select input 1332, associated with mode selection interface 1328, associated with mode selection component 1404, etc.) associated with the event detection component (e.g., event detector 1312, 1314, an event detection component, and so on) or status of a clock signal (e.g., internal oscillator 1406, external clock signal 1410, etc.) associated with the sensor (e.g., comprising exemplary MEMS acoustic sensor or microphone 1306).

In a further non-limiting aspect, (e.g., internal oscillator 1406, external clock signal 1410, etc.) associated with the sensor (e.g., comprising exemplary MEMS acoustic sensor or microphone 1306) can comprise one or more of a host clock signal (e.g., external clock signal 1410) or a signal of an oscillator housed within the package (e.g., internal oscillator 1406). In yet another non-limiting aspect, mode selection component (e.g., mode selection interface 1328, mode selection component 1404, etc.) can be further configured: to select an exemplary sleep mode based on the host clock signal (e.g., external clock signal 1410) determined to be at a logical low value (e.g., F_{ck}=0 at 1504 and V_{ck} does not equal a logical high-value at 1506); to select an exemplary event detection mode and initiate internal clock generation by the oscillator (e.g., internal oscillator 1406) based on the host clock signal (e.g., external clock signal 1410) determined to be at a logical high value (e.g., V_{ck} equals a logical high-value at 1506); to control the multiplexer (e.g., multiplexer 1326) to send the control signal (e.g., one or more exemplary control signals 1320, interrupt signals, interrupt control signals, I²C signals, etc.) on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.), for example, as further described herein, regarding FIGS. 3-9, in an exemplary event detection mode; to select an exemplary low-power audio mode and/or terminate internal clock generation by the oscillator (e.g., internal oscillator 1406) based on the host clock signal (e.g., external clock signal 1410) determined to comprise a low-frequency signal (e.g., F_{ck}=768 kHz); to control the multiplexer (e.g., multiplexer 1326) to send the signal (e.g., an analog signal 1316, a digital signal 1318) associated with the sound pressure waves on the output (e.g., a multiplexed output signal on a single output, such as, a solder pad, a pin, a contact, etc., associated with signal/interrupt output 1322, 1324 of a package) in an exemplary low-power audio mode, and/or to select an exemplary standard-performance mode based on the host clock signal (e.g., external clock signal 1410) determined to comprise a high-frequency signal (e.g., F_{ck}=2.4 MHz).

In further exemplary embodiments, the subject disclosure provides an exemplary sensor, comprising a MEMS sensor (e.g., MEMS acoustic sensor or microphone 1306) configured to process ultrasound pressure waves in an event detection mode. The exemplary sensor can further comprise an event detection component (e.g., event detector 1312, 1314, an event detection component, and so on) comprising an ASIC configured to detect a ultrasound pressure event associated with the ultrasound pressure waves and generate a control signal (e.g., one or more exemplary control signals 1320, interrupt signals, interrupt control signals, I²C signals, etc.) in response to receiving a signal (e.g., an analog signal 1316, a digital signal 1318) associated with the ultrasound pressure waves from the MEMS sensor (e.g., MEMS acoustic sensor or microphone 1306).

In another exemplary embodiment, an exemplary event detection component (e.g., event detector 1312, 1314, an event detection component, and so on) can be further configured to generate the control signal (e.g., one or more exemplary control signals 1320, interrupt signals, interrupt control signals, I²C signals, etc.) to wake up (e.g., wake up from a reduced power sleep mode) a Codec component (e.g., Codec 1416), a sensor hub (e.g., sensor hub 1414), or a system processor (e.g., a processor, a main processor, an applications processor (e.g., application processor 1418), etc.) associated with the sensor (e.g., comprising MEMS acoustic sensor or microphone 1306) from an exemplary low power mode in response to processing a multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with ultrasound pressure waves transduced by an exemplary MEMS acoustic sensor or microphone 1306) from the sensor (e.g., comprising MEMS acoustic sensor or microphone 1306). As further described herein, event detection component (e.g., event detector 1312, 1314, an event detection component, and so on) can be further configured to detect one or more of an ultrasonic signal, or a predefined ultrasound pattern as an ultrasound pressure event. In a non-limiting aspect, event detection component (e.g., event detector 1312, 1314, an event detection component, and so on) can be further configured to detect the ultrasound pressure event associated with the sound pressure waves based on the signal (e.g., an analog signal 1316, a digital signal 1318) associated with the ultrasound pressure waves transduced by an exemplary MEMS acoustic sensor or microphone 1306.

In further exemplary embodiments, an exemplary sensor can also comprise a package comprising a lid and a package substrate, wherein the package has a port adapted to receive the ultrasound pressure waves and an output (e.g., a solder pad, a pin, a contact, etc., associated with signal/interrupt output 1322, 1324) adapted to transmit the multiplexed output signal, and wherein the package houses the MEMS sensor (e.g., exemplary MEMS acoustic sensor or microphone 1306) and the event detection component (e.g., event detector 1312, 1314, an event detection component, and so on), for example, as further described herein, regarding FIGS. 3-9. In a non-limiting aspect, an exemplary package comprising the lid and the package substrate can also house a multiplexer (e.g., multiplexer 1326), as further described herein.

In exemplary embodiments, an exemplary sensor can further comprise a multiplexer (e.g., multiplexer 1326) configured to generate a multiplexed output signal (e.g., via signal/interrupt output 1322, 1324) in response to receiving the control signal (e.g., one or more exemplary control signals 1320, interrupt signals, interrupt control signals, I²C signals, etc.) and the signal (e.g., an analog signal 1316, a digital signal 1318) associated with the ultrasound pressure waves. For instance, as further described herein, multiplexer 1326 can be configured to combine and/or transmit one or more exemplary control signals 1320 (e.g., interrupt signals, interrupt control signals, I²C signals) and data comprising a signal (e.g., an analog signal 1316, a digital signal 1318) associated with ultrasound pressure waves transduced by an exemplary MEMS acoustic sensor or microphone 1306 as a multiplexed output signal on a single output (e.g., a solder pad, a pin, a contact, etc., associated with signal/interrupt output 1322, 1324) of a package (e.g., package comprising smart sensor 1302, 1304, 1402, etc.), for example, as further described herein, regarding FIGS. 3-9. Thus, an exemplary multiplexed output signal can comprise an interrupt comprising the control signal (e.g., one or more exemplary control signals 1320, interrupt signals, interrupt control signals, I²C signals, etc.) and data comprising the signal (e.g., an analog signal 1316, a digital signal 1318) associated with the ultrasound pressure waves.

In other exemplary embodiments, an exemplary sensor can also comprise a mode select component (e.g., mode selection interface 1328, mode selection component 1404, etc.) configured to set one mode from between several modes of the sensor (e.g., comprising exemplary MEMS acoustic sensor or microphone 1306) comprising one or more of an exemplary event detection mode, an exemplary low-power mode, an exemplary standard-performance mode, an exemplary ultrasonic mode, or an exemplary sleep mode, as further described herein. In a non-limiting aspect, an exemplary mode select component (e.g., mode selection interface 1328, mode selection component 1404, etc.) can be further configured to set one mode of the sensor (e.g., comprising exemplary MEMS acoustic sensor or microphone 1306) based in part on one, one or more of a signal on an interface (e.g., on a clock (ck) input 1334, on a mode select input 1332, associated with mode selection interface 1328, associated with mode selection component 1404, etc.) associated with the event detection component (e.g., event detector 1312, 1314, an event detection component, and so on) or status of a clock signal (e.g., internal oscillator 1406, external clock signal 1410, etc.) associated with the sensor (e.g., comprising exemplary MEMS acoustic sensor or microphone 1306).

In a further non-limiting aspect, (e.g., internal oscillator 1406, external clock signal 1410, etc.) associated with the sensor (e.g., comprising exemplary MEMS acoustic sensor or microphone 1306) can comprise one or more of a host clock signal (e.g., external clock signal 1410) or a signal of an oscillator housed within the package (e.g., internal oscillator 1406). In yet another non-limiting aspect, mode select component (e.g., mode selection interface 1328, mode selection component 1404, etc.) can be further configured: to select an exemplary sleep mode based on the host clock signal (e.g., external clock signal 1410) determined to be at a logical low value (e.g., F_{ck}=0 at 1504 and V_{ck} does not equal a logical high-value at 1506); configured to select an exemplary event detection mode and initiate internal clock generation by the oscillator (e.g., internal oscillator 1406) based on the host clock signal (e.g., external clock signal 1410) determined to be at a logical high value (e.g., V_{ck} equals a logical high-value at 1506); to control the multiplexer (e.g., multiplexer 1326) to send the control signal (e.g., one or more exemplary control signals 1320, interrupt signals, interrupt control signals, I²C signals, etc.) on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.), for example, as further described herein, regarding FIGS. 3-9, in an exemplary event detection mode; to select an exemplary low-power mode and/or terminate internal clock generation by the oscillator (e.g., internal oscillator 1406) based on the host clock signal (e.g., external clock signal 1410) determined to comprise a low-frequency signal (e.g., F_{ck}=768 kHz); to control the multiplexer (e.g., multiplexer 1326) to send the signal (e.g., an analog signal 1316, a digital signal 1318) associated with the ultrasound pressure waves on the output (e.g., a multiplexed output signal on a single output, such as, a solder pad, a pin, a contact, etc., associated with signal/interrupt output 1322, 1324 of a package) in an exemplary low-power mode; and/or to select an exemplary standard-performance mode based on the host clock signal (e.g., external clock signal 1410) determined to comprise a high-frequency signal (e.g., F_{ck}=2.4 MHz).

In further exemplary embodiments, the subject disclosure provides exemplary systems (e.g., exemplary systems 1400 and/or portions, components, subcomponents thereof, in any combination, etc.) comprising an exemplary MEMS sensor package (e.g., a package comprising one or more of smart sensor 1302, smart sensor 1304, smart sensor 1402, etc.), for example, as further described herein, regarding FIGS. 3-9, 13-15, etc. Exemplary MEMS sensor packages can be configured to process sound pressure waves (and/or ultrasound pressure waves) in an event detection mode and/or to transmit a multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves (and/or ultrasound pressure waves) transduced by an exemplary MEMS acoustic sensor or microphone 1306) comprising data associated with the sound pressure waves (and/or ultrasound pressure waves) and an interrupt on an output (e.g., a solder pad, a pin, a contact, etc., associated with signal/interrupt output 1322, 1324) associated with the package (e.g., a package comprising one or more of smart sensor 1302, smart sensor 1304, smart sensor 1402, etc.), for example, as further described herein, regarding FIGS. 3-9.

In addition, exemplary systems of the subject disclosure can also comprise one or more of an exemplary sensor hub (e.g., sensor hub 1414), an exemplary Coder/Decoder Digital Signal Processor (CODEC) (e.g., Codec 1416), or a host processor (e.g., a processor, a main processor, an applications processor (e.g., application processor 1418), etc.) associated with the sensor (e.g., comprising MEMS acoustic sensor or microphone 1306). For instance, in exemplary embodiments the one or more of exemplary sensor hub (e.g., sensor hub 1414), exemplary Coder/Decoder Digital Signal Processor (CODEC) (e.g., Codec 1416), or host processor (e.g., a processor, a main processor, an applications processor (e.g., application processor 1418), etc.) can be configured to receive at least a portion of the multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves (and/or ultrasound pressure waves) transduced by an exemplary MEMS acoustic sensor or microphone 1306) and can be configured to transmit a clock signal (e.g., external clock signal 1410, etc.) to the MEMS sensor package (e.g., a package comprising one or more of smart sensor 1302, smart sensor 1304, smart sensor 1402, etc.) based at least in part on the multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves (and/or ultrasound pressure waves) transduced by an exemplary MEMS acoustic sensor or microphone 1306).

In further embodiments, exemplary systems of the subject disclosure can further comprise a demultiplexer (not shown) associated with the one or more of exemplary sensor hub (e.g., sensor hub 1414), exemplary Coder/Decoder Digital Signal Processor (CODEC) (e.g., Codec 1416), or host processor (e.g., a processor, a main processor, an applications processor (e.g., application processor 1418), etc.). For instance, an exemplary embodiments, an exemplary demultiplexer can be configured to receive the multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves (and/or ultrasound pressure waves) transduced by an exemplary MEMS acoustic sensor or microphone 1306) and can be configured to transmit one or more of the data (e.g., an analog signal 1316, a digital signal 1318) associated with the sound pressure waves (and/or ultrasound pressure waves) or the interrupt to the one or more of exemplary sensor hub (e.g., sensor hub 1414), exemplary Coder/Decoder Digital Signal Processor (CODEC) (e.g., Codec 1416), or host processor (e.g., a processor, a main processor, an applications processor (e.g., application processor 1418), etc.). In addition, exemplary systems comprising an exemplary MEMS sensor package (e.g., a package comprising one or more of smart sensor 1302, smart sensor 1304, smart sensor 1402, etc.) can further comprise an oscillator (e.g., internal oscillator 1406, etc.) configured to power at least a portion of the MEMS sensor package (e.g., a package comprising one or more of smart sensor 1302, smart sensor 1304, smart sensor 1402, etc.) in an exemplary event detection mode. In a further non-limiting aspect, exemplary systems comprising an exemplary MEMS sensor package (e.g., a package comprising one or more of smart sensor 1302, smart sensor 1304, smart sensor 1402, etc.) can be configured to wake up (e.g., wake up from a reduced power sleep mode) one or more of the exemplary sensor hub (e.g., sensor hub 1414), the exemplary Coder/Decoder Digital Signal Processor (CODEC) (e.g., Codec 1416), or the host processor (e.g., a processor, a main processor, an applications processor (e.g., application processor 1418), etc.), for example, in response to receiving at least one of the interrupt or the data associated with the sound pressure waves in the multiplexed output signal.

In further non-limiting implementations, exemplary systems comprising an exemplary MEMS sensor package (e.g., a package comprising one or more of smart sensor 1302, smart sensor 1304, smart sensor 1402, etc.) can further comprise a mode select component (e.g., mode selection interface 1328, mode selection component 1404, etc.) configured: to select an exemplary sleep mode based on a clock signal (e.g., at a clock input 1334 comprising a solder pad, a pin, a contact, etc.) determined to be at a logical low value (e.g., F_{ck}=0 at 1504 and V_{ck} does not equal a logical high-value at 1506); to select an exemplary event detection mode and initiate internal clock generation by an oscillator (e.g., internal oscillator 1406) based on the clock signal (e.g., at a clock input 1334 comprising a solder pad, a pin, a contact, etc.) determined to be at a logical high value (e.g., V_{ck} equals a logical high-value at 1506); configured to control a multiplexer (e.g., multiplexer 1326) to send the control signal (e.g., one or more exemplary control signals 1320, interrupt signals, interrupt control signals, I²C signals, etc.) on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.), for example, as further described herein, regarding FIGS. 3-9, in an exemplary event detection mode; configured to select an exemplary low-power mode and/or terminate internal clock generation by the oscillator (e.g., internal oscillator 1406) based on the clock signal (e.g., at a clock input 1334 comprising a solder pad, a pin, a contact, etc.) determined to comprise a low-frequency signal (e.g., F_{ck}=768 kHz); to control the multiplexer (e.g., multiplexer 1326) to send data (e.g., an analog signal 1316, a digital signal 1318) associated with the sound pressure waves (and/or ultrasound pressure waves) on the output (e.g., a multiplexed output signal on a single output, such as, a solder pad, a pin, a contact, etc., associated with signal/interrupt output 1322, 1324 of a package) in an exemplary low-power mode; and/or to select an exemplary standard-performance mode based on the clock signal (e.g., at a clock input 1334 comprising a solder pad, a pin, a contact, etc.) determined to comprise a high-frequency signal (e.g., F_{ck}=2.4 MHz).

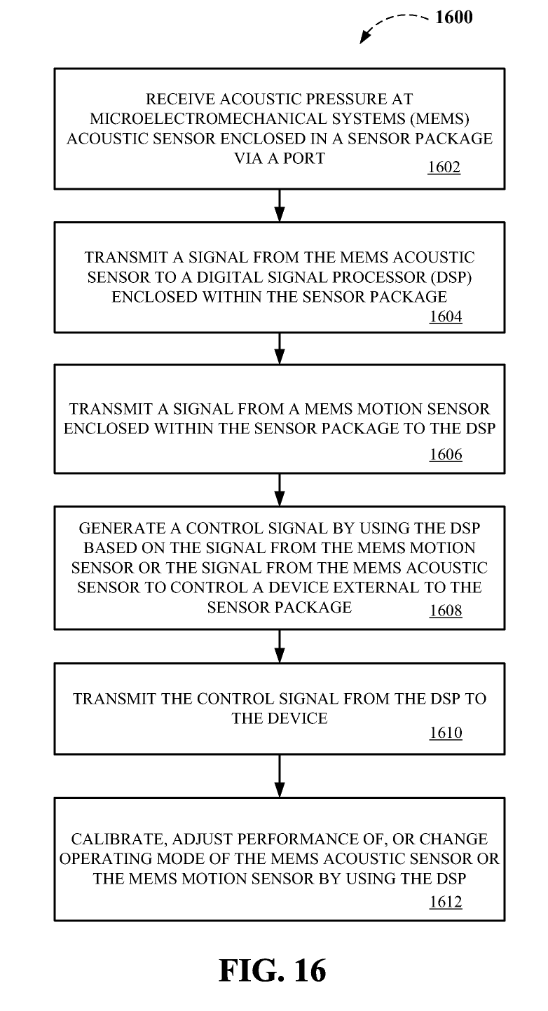

In view of the subject matter described supra, methods that can be implemented in accordance with the subject disclosure will be better appreciated with reference to the flowcharts of FIGS. 16-18. While for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

### Exemplary Methods

FIG. 16 depicts an exemplary flowchart of non-limiting methods associated with a smart sensor, according to various non-limiting aspects of the subject disclosure. As a non-limiting example, exemplary methods 1600 can comprise receiving acoustic pressure or acoustic waves at 1602. For instance, acoustic pressure or acoustic waves can be received by a MEMS acoustic sensor (e.g., MEMS acoustic sensor or microphone 102) enclosed in a sensor package (e.g., a sensor or microphone package comprising a MEMS acoustic sensor or microphone 102) comprising a lid (e.g., lid 304) and a package substrate (e.g., sensor or microphone package substrate 302) via a port (e.g., port 308) in the sensor package (e.g., a sensor or microphone package comprising a MEMS acoustic sensor or microphone 102) adapted to receive the acoustic pressure or acoustic waves) for example, as described above regarding FIGS. 3-9.

In an aspect, as described above regarding FIGS. 1 and 2, for example, the MEMS acoustic sensor (e.g., MEMS acoustic sensor or microphone 102) can be configured to operate at a voltage below 1.5 volts. In a further aspect, the MEMS acoustic sensor (e.g., MEMS acoustic sensor or microphone 102) can be configured to operate in an always-on mode, as described herein. For example, the MEMS acoustic sensor (e.g., MEMS acoustic sensor or microphone 102) can be included in a device such as host system 1000 (e.g., a feature phone, smartphone, smart watch, tablet, eReader, netbook, automotive navigation device, gaming console or device, wearable computing device) comprising a system processor (e.g., device 1010) and the MEMS acoustic sensor (e.g., MEMS acoustic sensor or microphone 102), wherein the system processor (e.g., device 1010) is located outside the sensor package. For example, system processor (e.g., device 1010) can include an integrated circuit (IC) for controlling functionality of a mobile phone (e.g., host system 1000).

Exemplary methods 1600 can further comprise transmitting a signal from the MEMS acoustic sensor (e.g., MEMS acoustic sensor or microphone 102) to a DSP (e.g., DSP 106/212) enclosed within a back cavity (e.g., back cavity 306) of the MEMS acoustic sensor (e.g., MEMS acoustic sensor or microphone 102) at 1604. At 1606, exemplary methods 1600 transmitting a signal from a MEMS motion sensor (e.g., MEMS motion sensor 202) enclosed within the sensor package to the DSP (e.g., DSP 106/212).

In a further non-limiting aspect, exemplary methods 1600, at 1608, can comprise generating a control signal (e.g., control signal 104/204) by using the DSP (e.g., DSP 106/212), wherein the control signal (e.g., DSP 106/212) can be adapted to facilitate controlling a device, such as system processor (e.g., device 1010), external to the sensor package, as further described herein. As a non-limiting example, generating the control signal (e.g., control signal 104/204) by using the DSP (e.g., DSP 106/212) can include generating the control signal (e.g., control signal 104/204) based on one or more of the signal from the MEMS motion sensor (e.g., MEMS motion sensor 202), the signal from the (e.g., MEMS acoustic sensor or microphone 102), signals from other sensors, and/or any combination thereof.

For instance, generating the control signal (e.g., control signal 104/204) with the DSP (e.g., DSP 106/212) can include generating a wake-up signal adapted to facilitate powering up the device, such as system processor (e.g., device 1010), from a low-power state. As such, at 1610, exemplary methods 1600 can further comprise transmitting the control signal (e.g., control signal 104/204) from the DSP (e.g., DSP 106/212) to the device, such as system processor (e.g., device 1010) to facilitate powering up the device. In addition, at 1612, exemplary methods 1600 can also comprise calibrating, adjusting performance of, or changing operating mode of one or more of the MEMS motion sensor (e.g., MEMS motion sensor 202) or the (e.g., MEMS acoustic sensor or microphone 102) by using the DSP (e.g., DSP 106/212).

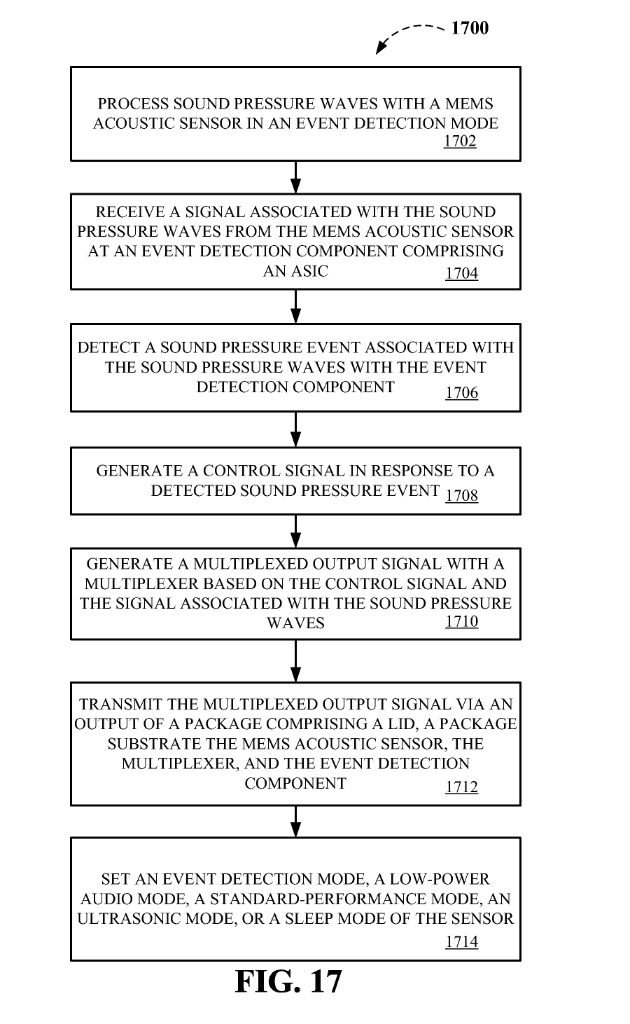

FIG. 17 depicts another exemplary flowchart of non-limiting methods 1700 associated with an exemplary smart sensor (e.g., exemplary smart sensor 1302, 1304, 1402, etc.). For instance, exemplary methods 1700 can comprise as 1702 processing sound pressure waves with a MEMS acoustic sensor (e.g., MEMS acoustic sensor or microphone 1306) in an event detection mode. At 1704, exemplary methods 1700 can further comprise receiving a signal (e.g., an analog signal 1316, a digital signal 1318) associated with the sound pressure waves from the MEMS acoustic sensor (e.g., MEMS acoustic sensor or microphone 1306) at an event detection component (e.g., event detector 1312, 1314, an event detection component, and so on) comprising an ASIC.

In addition, at 1706, exemplary methods 1700 can comprise detecting a sound pressure event associated with the sound pressure waves with the event detection component (e.g., event detector 1312, 1314, an event detection component, and so on). As a non-limiting example, at 1706, exemplary methods 1700 can comprise detecting, one or more of a sound, a human voice, an ultrasonic signal, a keyword, a voice activity, or a predefined sound pattern as the sound pressure event, for example, as further described herein. In a further non-limiting example, at 1706, exemplary methods 1700 can also comprise detecting the sound pressure event associated with the sound pressure waves based on the signal (e.g., an analog signal 1316, a digital signal 1318) associated with the sound pressure waves.

Exemplary methods 1700 can further comprise generating a control signal (e.g., one or more exemplary control signals 1320, interrupt signals, interrupt control signals, I²C signals, etc.) in response to the detecting the sound pressure event at 1708. As a non-limiting example, exemplary methods 1700 can also comprise generating the control signal (e.g., one or more exemplary control signals 1320, interrupt signals, interrupt control signals, I²C signals, etc.) to wake up (e.g., wake up from a reduced power sleep mode) a coder-decoder (e.g., Codec 1416) component, a sensor hub (e.g., sensor hub 1414), or a system processor (e.g., a processor, a main processor, an applications processor (e.g., application processor 1418), etc.) associated with the smart sensor (e.g., exemplary smart sensor 1302, 1304, 1402, etc.) from an exemplary low power mode in response to processing a multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with sound pressure waves transduced by an exemplary MEMS acoustic sensor or microphone 1306) from the smart sensor (e.g., exemplary smart sensor 1302, 1304, 1402, etc.).

At 1710, exemplary methods 1700 can also comprise generating a multiplexed output signal (e.g., via signal/interrupt output 1322, 1324) with a multiplexer (e.g., multiplexer 1326) based on the control signal (e.g., one or more exemplary control signals 1320, interrupt signals, interrupt control signals, I²C signals, etc.) and the signal (e.g., an analog signal 1316, a digital signal 1318) associated with the sound pressure waves. For instance, as further described herein, multiplexer 1326 can be configured to combine and/or transmit one or more exemplary control signals 1320 (e.g., interrupt signals, interrupt control signals, I²C signals) and data comprising a signal (e.g., an analog signal 1316, a digital signal 1318) associated with sound pressure waves transduced by an exemplary MEMS acoustic sensor or microphone 1306 as a multiplexed output signal on a single output (e.g., a solder pad, a pin, a contact, etc., associated with signal/interrupt output 1322, 1324) of a package (e.g., package comprising smart sensor 1302, 1304, 1402, etc.), for example, as further described herein, regarding FIGS. 3-9. As a further non-limiting example, exemplary methods 1700, at 1710, can also comprise multiplexing an interrupt comprising the control signal (e.g., one or more exemplary control signals 1320, interrupt signals, interrupt control signals, I²C signals, etc.) and data comprising the signal (e.g., an analog signal 1316, a digital signal 1318) associated with the sound pressure waves.

Exemplary methods 1700 can further comprise, at 1712, transmitting the multiplexed output signal via an output (e.g., via signal/interrupt output 1322, 1324) of a package (e.g., package comprising smart sensor 1302, 1304, 1402, etc.) comprising a lid, a package substrate, the MEMS acoustic sensor (e.g., MEMS acoustic sensor or microphone 1306), the multiplexer (e.g., multiplexer 1326), and the event detection component (e.g., event detector 1312, 1314, an event detection component, and so on), for example, as further described herein, regarding FIGS. 3-9

In addition, exemplary methods 1700 can further comprise, at 1714, setting one or more modes (e.g., via a mode selection component, mode selection interface 1328, mode selection component 1404, etc.) of the smart sensor (e.g., exemplary smart sensor 1302, 1304, 1402, etc.) from between several modes of the smart sensor (e.g., exemplary smart sensor 1302, 1304, 1402, etc.) comprising an exemplary event detection mode, an exemplary low-power audio mode, an exemplary standard-performance mode, an exemplary ultrasonic mode, and/or an exemplary sleep mode, for example, as further described herein. As a non-limiting example, exemplary methods 1700 can further comprise, at 1714, setting the one mode of the smart sensor (e.g., exemplary smart sensor 1302, 1304, 1402, etc.) based in part on one or more of a signal on an interface (e.g., on a clock (ck) input 1334, on a mode select input 1332, associated with mode selection interface 1328, associated with mode selection component 1404, etc.) associated with the event detection component (e.g., event detector 1312, 1314, an event detection component, and so on) or status of a clock signal (e.g., internal oscillator 1406, external clock signal 1410, etc.) associated with the smart sensor (e.g., exemplary smart sensor 1302, 1304, 1402, etc.). As a further non-limiting example, a clock signal (e.g., internal oscillator 1406, external clock signal 1410, etc.) associated with the smart sensor (e.g., exemplary smart sensor 1302, 1304, 1402, etc.) can comprise one or more of a host clock signal (e.g., external clock signal 1410, etc.) or a signal of an oscillator (e.g., internal oscillator 1406, etc.) housed within the package.

Accordingly, in further non-limiting embodiments exemplary methods 1700 can further comprise, at 1714, one or more of: selecting an exemplary sleep mode based on the host clock signal (e.g., external clock signal 1410, etc.) determined to be at a logical low value (e.g., F_{ck}=0 at 1504 and V_{ck} does not equal a logical high-value at 1506); selecting an exemplary event detection mode and initiating internal clock generation by the oscillator (e.g., internal oscillator 1406, etc.) based on the host clock signal (e.g., external clock signal 1410, etc.) determined to be at a logical high value (e.g., V_{ck} equals a logical high-value at 1506); controlling the multiplexer (e.g., multiplexer 1326) to send the control signal (e.g., one or more exemplary control signals 1320, interrupt signals, interrupt control signals, I²C signals, etc.) on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.) in an exemplary event detection mode; selecting an exemplary low-power audio mode and terminating internal clock generation by the oscillator (e.g., internal oscillator 1406, etc.) based on the host clock signal determined to comprise a low-frequency signal (e.g., F_{ck}=768 kHz); controlling the multiplexer (e.g., multiplexer 1326) to send the signal (e.g., an analog signal 1316, a digital signal 1318) associated with the sound pressure waves on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.) in the exemplary low-power audio mode; and/or selecting an exemplary standard-performance mode based on the host clock signal (e.g., external clock signal 1410, etc.) determined to comprise a high-frequency signal (e.g., F_{ck}=2.4 MHz).

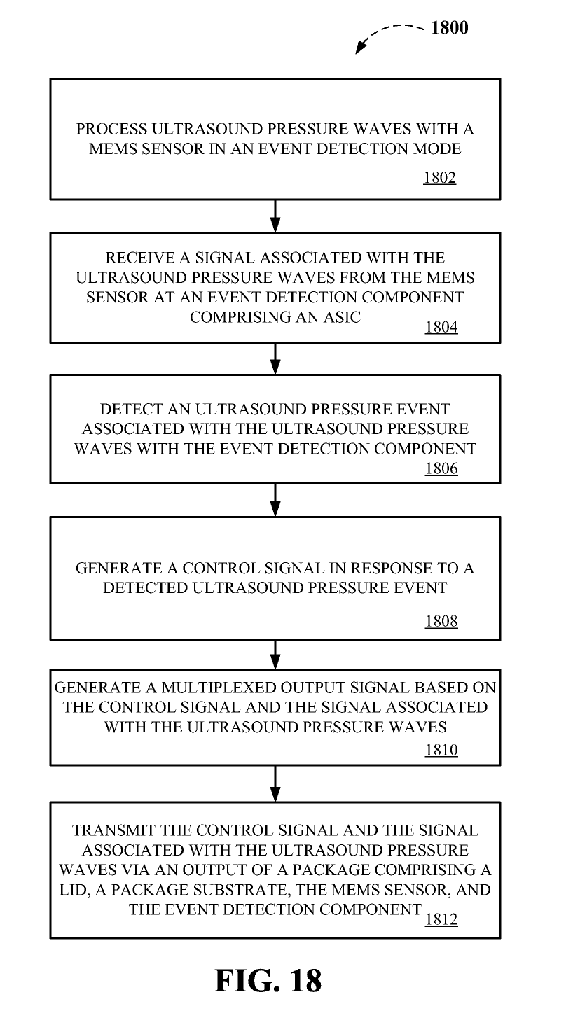

FIG. 18 depicts a further non-limiting flowchart of exemplary methods 1800 associated with an exemplary smart sensor (e.g., exemplary smart sensor 1302, 1304, 1402, etc.). For instance, exemplary methods 1800 can comprise as 1802 processing ultrasound pressure waves with a MEMS sensor (e.g., MEMS acoustic sensor or microphone 1306) in an event detection mode. At 1804, exemplary methods 1800 can further comprise receiving a signal (e.g., an analog signal 1316, a digital signal 1318) associated with the ultrasound pressure waves from the MEMS sensor (e.g., MEMS acoustic sensor or microphone 1306) at an event detection component (e.g., event detector 1312, 1314, an event detection component, and so on) comprising an ASIC.

In addition, at 1806, exemplary methods 1800 can comprise detecting an ultrasound pressure event associated with the ultrasound pressure waves with the event detection component (e.g., event detector 1312, 1314, an event detection component, and so on). As a non-limiting example, at 1806, exemplary methods 1800 can comprise detecting, one or more of an ultrasonic signal, or a predefined ultrasound pattern as the ultrasound pressure event, for example, as further described herein. In a further non-limiting example, at 1806, exemplary methods 1800 can also comprise detecting the ultrasound pressure event associated with the ultrasound pressure waves based on the signal (e.g., an analog signal 1316, a digital signal 1318) associated with the ultrasound pressure waves.

Exemplary methods 1800 can further comprise generating a control signal (e.g., one or more exemplary control signals 1320, interrupt signals, interrupt control signals, I²C signals, etc.) in response to the detecting the ultrasound pressure event at 1808. As a non-limiting example, exemplary methods 1800 can also comprise generating the control signal (e.g., one or more exemplary control signals 1320, interrupt signals, interrupt control signals, I²C signals, etc.) to wake up (e.g., wake up from a reduced power sleep mode) a coder-decoder (e.g., Codec 1416) component, a sensor hub (e.g., sensor hub 1414), or a system processor (e.g., a processor, a main processor, an applications processor (e.g., application processor 1418), etc.) associated with the smart sensor (e.g., exemplary smart sensor 1302, 1304, 1402, etc.) from an exemplary low power mode in response to processing a multiplexed output signal (e.g., one or more exemplary control signals (e.g., control signals 1320, interrupt signals, interrupt control signals, I²C signals, and data comprising a signal (e.g., an analog signal 1316, a digital signal 1318) associated with ultrasound pressure waves transduced by an exemplary MEMS acoustic sensor or microphone 1306) from the smart sensor (e.g., exemplary smart sensor 1302, 1304, 1402, etc.).

At 1810, exemplary methods 1800 can also comprise generating a multiplexed output signal (e.g., via signal/interrupt output 1322, 1324) with a multiplexer (e.g., multiplexer 1326), housed within a package (e.g., package comprising smart sensor 1302, 1304, 1402, etc.) comprising a lid, a package substrate, the MEMS sensor (e.g., MEMS acoustic sensor or microphone 1306), the multiplexer (e.g., multiplexer 1326), and the event detection component (e.g., event detector 1312, 1314, an event detection component, and so on), for example, as further described herein, regarding FIGS. 3-9, based on the control signal (e.g., one or more exemplary control signals 1320, interrupt signals, interrupt control signals, I²C signals, etc.) and the signal (e.g., an analog signal 1316, a digital signal 1318) associated with the ultrasound pressure waves. For instance, as further described herein, multiplexer 1326 housed within a package (e.g., package comprising smart sensor 1302, 1304, 1402, etc.) can be configured to combine and/or transmit one or more exemplary control signals 1320 (e.g., interrupt signals, interrupt control signals, I²C signals) and data comprising a signal (e.g., an analog signal 1316, a digital signal 1318) associated with ultrasound pressure waves transduced by an exemplary MEMS acoustic sensor or microphone 1306 as a multiplexed output signal on a single output (e.g., a solder pad, a pin, a contact, etc., associated with signal/interrupt output 1322, 1324) of a package (e.g., package comprising smart sensor 1302, 1304, 1402, etc.), for example, as further described herein, regarding FIGS. 3-9. As a further non-limiting example, exemplary methods 1800, at 1810, can also comprise multiplexing an interrupt comprising the control signal (e.g., one or more exemplary control signals 1320, interrupt signals, interrupt control signals, I²C signals, etc.) and data comprising the signal (e.g., an analog signal 1316, a digital signal 1318) associated with the ultrasound pressure waves.

Exemplary methods 1800 can further comprise, at 1812, transmitting the control signal (e.g., one or more exemplary control signals 1320, interrupt signals, interrupt control signals, I²C signals, etc.) and the signal (e.g., an analog signal 1316, a digital signal 1318) associated with the ultrasound pressure waves via an output (e.g., via signal/interrupt output 1322, 1324) of a package (e.g., package comprising smart sensor 1302, 1304, 1402, etc.) comprising a lid, a package substrate, the MEMS sensor (e.g., MEMS acoustic sensor or microphone 1306), the multiplexer (e.g., multiplexer 1326), and the event detection component (e.g., event detector 1312, 1314, an event detection component, and so on), for example, as further described herein, regarding FIGS. 3-9.

In addition, exemplary methods 1800 can further comprise setting one or more modes (e.g., via a mode selection component, mode selection interface 1328, mode selection component 1404, etc.) of the smart sensor (e.g., exemplary smart sensor 1302, 1304, 1402, etc.) from between several modes of the smart sensor (e.g., exemplary smart sensor 1302, 1304, 1402, etc.) comprising an exemplary event detection mode, an exemplary low-power mode, an exemplary standard-performance mode, an exemplary ultrasonic mode, and/or an exemplary sleep mode, for example, as further described herein.

As a non-limiting example, exemplary methods 1800 can further comprise monitoring a clock signal (e.g., internal oscillator 1406, external clock signal 1410, etc.) associated with the smart sensor (e.g., exemplary smart sensor 1302, 1304, 1402, etc.) comprising monitoring one or more of a host clock signal (e.g., external clock signal 1410, etc.) or a signal of an oscillator (e.g., internal oscillator 1406, etc.) housed within the package (e.g., package comprising smart sensor 1302, 1304, 1402, etc.) comprising a lid, a package substrate, the MEMS sensor (e.g., MEMS acoustic sensor or microphone 1306), the multiplexer (e.g., multiplexer 1326), and the event detection component (e.g., event detector 1312, 1314, an event detection component, and so on), for example, as further described herein, regarding FIGS. 3-9. Thus, exemplary methods 1800 can further comprise setting the one mode of the smart sensor (e.g., exemplary smart sensor 1302, 1304, 1402, etc.) based in part on one or more of a signal on an interface (e.g., on a clock (ck) input 1334, on a mode select input 1332, associated with mode selection interface 1328, associated with mode selection component 1404, etc.) associated with the event detection component (e.g., event detector 1312, 1314, an event detection component, and so on) or status of a clock signal (e.g., internal oscillator 1406, external clock signal 1410, etc.) associated with the smart sensor (e.g., exemplary smart sensor 1302, 1304, 1402, etc.).

Accordingly, in further non-limiting embodiments, exemplary methods 1800 can further comprise one or more of: selecting an exemplary sleep mode based on the host clock signal (e.g., external clock signal 1410, etc.) determined to be at a logical low value (e.g., F_{ck}=0 at 1504 and V_{ck} does not equal a logical high-value at 1506); selecting an exemplary event detection mode and initiating internal clock generation by the oscillator (e.g., internal oscillator 1406, etc.) based on the host clock signal (e.g., external clock signal 1410, etc.) determined to be at a logical high value (e.g., V_{ck} equals a logical high-value at 1506); controlling the multiplexer (e.g., multiplexer 1326) to send the control signal (e.g., one or more exemplary control signals 1320, interrupt signals, interrupt control signals, I²C signals, etc.) on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.) in an exemplary event detection mode; selecting an exemplary low-power mode and terminating internal clock generation by the oscillator (e.g., internal oscillator 1406, etc.) based on the host clock signal determined to comprise a low-frequency signal (e.g., F_{ck}=768 kHz); controlling the multiplexer (e.g., multiplexer 1326) to send the signal (e.g., an analog signal 1316, a digital signal 1318) associated with the sound pressure waves on the output (e.g., a multiplexed output signal on a single output, such as, a solder pad, a pin, a contact, etc., associated with signal/interrupt output 1322, 1324 of a package, such as, a package comprising smart sensor 1302, 1304, 1402, etc.) in the exemplary low-power mode; and/or selecting an exemplary standard-performance mode based on the host clock signal (e.g., external clock signal 1410, etc.) determined to comprise a high-frequency signal (e.g., F_{ck}=2.4 MHz).

However, various exemplary implementations of exemplary methods 1600, 1700, and/or 1800 as described can additionally, or alternatively, include other process steps associated with features or functionality of sensors, smart sensors, microphones, sensors or microphone packages, and so on, as further detailed herein, for example, regarding FIGS. 1-15.

What has been described above includes examples of the embodiments of the subject disclosure. It is, of course, not possible to describe every conceivable combination of configurations, components, and/or methods for purposes of describing the claimed subject matter, but it is to be appreciated that many further combinations and permutations of the various embodiments are possible. Accordingly, the claimed subject matter is intended to embrace all such alterations, modifications, and variations that fall within the spirit and scope of the appended claims. While specific embodiments and examples are described in subject disclosure for illustrative purposes, various modifications are possible that are considered within the scope of such embodiments and examples, as those skilled in the relevant art can recognize.

As used in this application, the terms “component,” “module,” “device” and “system” are intended to refer to a computer-related entity, either hardware, a combination of hardware and software, software, or software in execution. As one example, a component or module can be, but is not limited to being, a process running on a processor, a processor or portion thereof, a hard disk drive, multiple storage drives (of optical and/or magnetic storage medium), an object, an executable, a thread of execution, a program, and/or a computer. By way of illustration, both an application running on a server and the server can be a component or module. One or more components or modules scan reside within a process and/or thread of execution, and a component or module can be localized on one computer or processor and/or distributed between two or more computers or processors.

As used herein, the term to “infer” or “inference” refer generally to the process of reasoning about or inferring states of the system, and/or environment from a set of observations as captured via events, signals, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the words “example” or “exemplary” is used herein to mean serving as an example, instance, or illustration. Any aspect or design described herein as “exemplary” is not necessarily to be construed as preferred or advantageous over other aspects or designs. Rather, use of the word, “exemplary,” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while an aspect may have been disclosed with respect to only one of several embodiments, such feature may be combined with one or more other features of the other embodiments as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A sensor, comprising:
a microelectromechanical systems (MEMS) acoustic sensor configured to process sound pressure waves in an event detection mode;
an event detection component comprising an application specific integrated circuit (ASIC) configured to detect a sound pressure event associated with the sound pressure waves and generate a control signal in response to receiving a signal associated with the sound pressure waves from the MEMS acoustic sensor;
a multiplexer configured to generate a multiplexed output signal in response to receiving the control signal and the signal associated with the sound pressure waves; and
a package comprising a lid and a package substrate, wherein the package has a port adapted to receive the sound pressure waves and an output adapted to transmit the multiplexed output signal, and wherein the package houses the MEMS acoustic sensor, the multiplexer, and the event detection component.

2. The sensor of claim 1, wherein the multiplexed output signal comprises an interrupt comprising the control signal and data comprising the signal associated with the sound pressure waves.

3. The sensor of claim 1, wherein the event detection component is further configured to generate the control signal to wake up a coder-decoder (CODEC) component, a sensor hub, or a system processor associated with the sensor from a low power mode in response to processing the multiplexed output signal from the sensor.

4. The sensor of claim 1, wherein the event detection component is further configured to detect at least one of a sound, a human voice, an ultrasonic signal, a keyword, a voice activity, or a predefined sound pattern as the sound pressure event.

5. The sensor of claim 1, wherein the event detection component is further configured to detect the sound pressure event associated with the sound pressure waves based on the signal associated with the sound pressure waves comprising an analog signal.

6. The sensor of claim 1, wherein the event detection component is further configured to detect the sound pressure event associated with the sound pressure waves based on the signal associated with the sound pressure waves comprising a digital signal.

7. The sensor of claim 1, further comprising:
a mode selection component configured to set one mode from between several modes of the sensor comprising at least one of the event detection mode, low-power audio mode, standard-performance mode, ultrasonic mode, or a sleep mode.

8. The sensor of claim 7, wherein the mode selection component is further configured to set one mode of the sensor based in part on one at least of a signal on an interface associated with the event detection component or status of a clock signal associated with the sensor.

9. The sensor of claim 7, wherein the clock signal associated with the sensor comprises at least one of a host clock signal or a signal of an oscillator housed within the package, and wherein the mode selection component is further configured to select the sleep mode based on the host clock signal determined to be at a logical low value, to select the event detection mode and initiate internal clock generation by the oscillator based on the host clock signal determined to be at a logical high value, to control the multiplexer to send the control signal on the output in the event detection mode, to select the low-power audio mode and terminate internal clock generation by the oscillator based on the host clock signal determined to comprise a low-frequency signal, to control the multiplexer to send the signal associated with the sound pressure waves on the output in the low-power audio mode, and to select the standard-performance mode based on the host clock signal determined to comprise a high-frequency signal.

10. A sensor, comprising:
a microelectromechanical systems (MEMS) sensor configured to process ultrasound pressure waves in an event detection mode;
an event detection component comprising an application specific integrated circuit (ASIC) configured to detect an ultrasound pressure event associated with the ultrasound pressure waves and generate a control signal in response to receiving a signal associated with the ultrasound pressure waves from the MEMS sensor;
a package comprising a lid and a package substrate, wherein the package has an output adapted to transmit the control signal and the signal associated with the ultrasound pressure waves, and wherein the package houses the MEMS sensor and the event detection component.

12. The sensor of claim 10, wherein the event detection component is further configured to generate the control signal to wake up a coder-decoder (CODEC) component, a sensor hub, or a system processor associated with the sensor from a low power mode in response to processing the multiplexed output signal from the sensor.

13. The sensor of claim 10, wherein the event detection component is further configured to detect the ultrasound pressure event associated with the ultrasound pressure waves based on the signal associated with the ultrasound pressure waves comprising an analog signal.

14. The sensor of claim 10, wherein the event detection component is further configured to detect the ultrasound pressure event associated with the ultrasound pressure waves based on the signal associated with the ultrasound pressure waves comprising a digital signal.

15. The sensor of claim 10, further comprising:
a multiplexer configured to generate a multiplexed output signal in response to receiving the control signal and the signal associated with the ultrasound pressure waves.

16. The sensor of claim 15, wherein the multiplexed output signal comprises an interrupt comprising the control signal and data comprising the signal associated with the ultrasound pressure waves.

17. The sensor of claim 15, further comprising:
a mode select component configured to set one mode from between several modes of the sensor comprising at least one of the event detection mode, low-power mode, standard-performance mode, or a sleep mode.

18. The sensor of claim 17, wherein a clock signal associated with the sensor comprises at least one of a host clock signal or a signal of an oscillator housed within the package, and wherein the mode select component is further configured to select the sleep mode based on the host clock signal determined to be at a logical low value, to select the event detection mode and initiate internal clock generation by the oscillator based on the host clock signal determined to be at a logical high value, to control the multiplexer to send the control signal on the output in the event detection mode, to select the low-power mode and terminate internal clock generation by the oscillator based on the host clock signal determined to comprise a low-frequency signal, to control the multiplexer to send the signal associated with the ultrasound pressure waves on the output in the low-power mode, and to select the standard-performance mode based on the host clock signal determined to comprise a high-frequency signal.

19. A method, comprising:
processing sound pressure waves with a microelectromechanical systems (MEMS) acoustic sensor in an event detection mode;
receiving a signal associated with the sound pressure waves from the MEMS acoustic sensor at an event detection component comprising an application specific integrated circuit (ASIC);
detecting a sound pressure event associated with the sound pressure waves with the event detection component;
generating a control signal in response to the detecting the sound pressure event;
generating a multiplexed output signal with a multiplexer based on the control signal and the signal associated with the sound pressure waves; and
transmitting the multiplexed output signal via an output of a package comprising a lid, a package substrate, the MEMS acoustic sensor, the multiplexer, and the event detection component.

20. The method of claim 19, wherein the generating the multiplexed output signal comprises multiplexing an interrupt comprising the control signal and data comprising the signal associated with the sound pressure waves.

21. The method of claim 19, wherein the generating the control signal comprises generating the control signal to wake up a coder-decoder (CODEC) component, a sensor hub, or a system processor associated with the sensor from a low power mode in response to processing the multiplexed output signal from the sensor.

22. The method of claim 19, wherein the detecting the sound pressure event comprising detecting at least one of a sound, a human voice, an ultrasonic signal, a keyword, a voice activity, or a predefined sound pattern as the sound pressure event.

23. The method of claim 19, wherein the detecting the sound pressure event associated with the sound pressure waves comprises detecting the sound pressure event associated with the sound pressure waves based on the signal associated with the sound pressure waves comprising an analog signal.

24. The method of claim 19, wherein the detecting the sound pressure event associated with the sound pressure waves comprises detecting the sound pressure event associated with the sound pressure waves based on the signal associated with the sound pressure waves comprising a digital signal.

25. The method of claim 19, further comprising:
setting one mode of the sensor from between several modes of the sensor comprising setting at least one of the event detection mode, a low-power audio mode, a standard-performance mode, an ultrasonic mode, or a sleep mode.

26. The method of claim 25, wherein the setting the one mode comprises setting the one mode of the sensor based in part on one at least of a signal on an interface associated with the event detection component or status of a clock signal associated with the sensor.

27. The method of claim 26, wherein the clock signal associated with the sensor comprises at least one of a host clock signal or a signal of an oscillator housed within the package, further comprising:
selecting the sleep mode based on the host clock signal determined to be at a logical low value;
selecting the event detection mode and initiating internal clock generation by the oscillator based on the host clock signal determined to be at a logical high value;
controlling the multiplexer to send the control signal on the output in the event detection mode;
selecting the low-power audio mode and terminating internal clock generation by the oscillator based on the host clock signal determined to comprise a low-frequency signal;
controlling the multiplexer to send the signal associated with the sound pressure waves on the output in the low-power audio mode; and
selecting the standard-performance mode based on the host clock signal determined to comprise a high-frequency signal.

28. A method, comprising:
processing ultrasound pressure waves with a microelectromechanical systems (MEMS) sensor in an event detection mode;
receiving a signal associated with the ultrasound pressure waves from the MEMS sensor at an event detection component comprising an application specific integrated circuit (ASIC);
detecting an ultrasound pressure event associated with the ultrasound pressure waves with the event detection component;
generating a control signal in response to the detecting the ultrasound pressure event; and
transmitting the control signal and the signal associated with the ultrasound pressure waves via an output of a package comprising a lid, a package substrate, the MEMS sensor, and the event detection component.

29. The sensor of claim 28, wherein the generating the control signal comprises generating the control signal to wake up a coder-decoder (CODEC) component, a sensor hub, or a system processor associated with the sensor from a low power mode in response to processing the multiplexed output signal from the sensor.

30. The method of claim 28, wherein the detecting the ultrasound pressure event associated with the ultrasound pressure waves comprises detecting the ultrasound pressure event associated with the ultrasound pressure waves based on the signal associated with the ultrasound pressure waves comprising an analog signal.

31. The method of claim 28, wherein the detecting the ultrasound pressure event associated with the ultrasound pressure waves comprises detecting the ultrasound pressure event associated with the ultrasound pressure waves based on the signal associated with the ultrasound pressure waves comprising a digital signal.

32. The method of claim 28, further comprising:
generating a multiplexed output signal with a multiplexer housed with the package based on the control signal and the signal associated with the ultrasound pressure waves.

33. The method of claim 32, wherein the generating the multiplexed output signal comprises multiplexing an interrupt comprising the control signal and data comprising the signal associated with the ultrasound sound pressure waves.

34. The method of claim 32, further comprising:
monitoring a clock signal associated with the sensor comprising monitoring at least one of a host clock signal or a signal of an oscillator housed within the package;
selecting a sleep mode based on the host clock signal determined to be at a logical low value;
selecting an event detection mode and initiating internal clock generation by the oscillator based on the host clock signal determined to be at a logical high value;
controlling the multiplexer to send the control signal on the output in the event detection mode;
selecting a low-power mode and terminating internal clock generation by the oscillator based on the host clock signal determined to comprise a low-frequency signal;
controlling the multiplexer to send the signal associated with the ultrasound pressure waves on the output in the low-power mode; and
selecting a standard-performance mode based on the host clock signal determined to comprise a high-frequency signal.

35. A system comprising:
a microelectromechanical systems (MEMS) sensor package configured to process sound pressure waves in an event detection mode and to transmit a multiplexed output signal comprising data associated with the sound pressure waves and an interrupt on an output associated with the package;
at least one of a sensor hub, a Coder/Decoder Digital Signal Processor (CODEC), or a host processor configured to receive at least a portion of the multiplexed output signal and to transmit a clock signal to the MEMS sensor package based at least in part on the multiplexed output signal; and
a demultiplexer associated with the at least one of the sensor hub, the CODEC, or the host processor configured to receive the multiplexed output signal and transmit at least one of the data associated with the sound pressure waves or the interrupt to the at least one of the sensor hub, the CODEC, or the host processor.

36. The system of claim 35, wherein the MEMS sensor package further comprises an oscillator that powers at least a portion of the MEMS sensor package in the event detection mode.

37. The system of claim 36, wherein the MEMS sensor package further comprises a mode select component configured to select a sleep mode based on the clock signal determined to be at a logical low value, to select the event detection mode and initiate internal clock generation by the oscillator based on the clock signal determined to be at a logical high value, to control a multiplexer associated with the MEMS sensor package to send the interrupt on the output in the event detection mode, to select a low-power mode and terminate internal clock generation by the oscillator based on the clock signal determined to comprise a low-frequency signal, to control the multiplexer to send the data associated with the sound pressure waves on the output in the low-power mode, and to select a standard-performance mode based on the clock signal determined to comprise a high-frequency signal.

38. The system of claim 35, wherein the at least one of the sensor hub, the CODEC, or the host processor is configured to wake up from a reduced power mode in response to receiving at least one of the interrupt or the data associated with the sound pressure waves in the multiplexed output signal.
